(19) United States
(12) Patent Application Publication
(10) Pub. No.: US 2025/0301411 A1
(43) Pub. Date: Sep. 25, 2025

(54) TECHNIQUES FOR MULTIPLEXING DATA AND NON-DATA SIGNALS

(71) Applicant: QUALCOMM INCORPORATED, San Diego, CA (US)

(72) Inventors: Ahmed Elshafie, San Diego, CA (US); Yuchul Kim, San Diego, CA (US); Zhikun Wu, Beijing (CN); Seyedkianoush Hosseini, San Diego, CA (US); Huilin Xu, Temecula, CA (US); Linhai He, San Diego, CA (US)

(21) Appl. No.: 18/869,230

(22) PCT Filed: Jul. 12, 2022
(86) PCT No.: PCT/CN2022/105065

§ 371 Date: Nov. 25, 2024

(51) Int. Cl. H04W 52/18; H02J 50/00; H04L 5/00

(52) U.S. Cl. CPC H04W 52/18; H02J 50/001; H04L 5/0044

(57) ABSTRACT

Methods, systems, and devices for wireless communications are described. A wireless device may receive scheduling information that schedules temporally overlapping transmissions by the wireless device of a data signal and an additional signal, where the additional signal includes an artificial noise signal, an energy signal associated with an energy-harvesting device, or both. The wireless device may then align a starting symbol of the additional signal with a starting symbol of the data signal based on the data signal and the additional signal being scheduled to temporally overlap, and may transmit the data signal and the additional signal based on the aligning.

### CROSS REFERENCE

The present Application is a 371 national stage filing of International PCT Application No. PCT/CN2022/105065 by Elshafie et al. entitled “TECHNIQUES FOR MULTIPLEXING DATA AND NON-DATA SIGNALS,” filed Jul. 12, 2022, which is assigned to the assignee hereof, and which is expressly incorporated by reference in its entirety herein.

### TECHNICAL FIELD

The following relates to wireless communications, including techniques for multiplexing data and non-data signals.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems facilitate communication of different types of signals, including data signals and non-data signals. Data signals may include information that is to be decoded by the receiver, such as control channel and/or shared channel communications. Comparatively, non-data signals may not include any information that is to be decoded by the receiver, and may include energy signals, artificial noise signals, or both. However, the presence of non-data signals may detrimentally affect the transmission of data signals within wireless communications systems, and detrimentally affect the reliability with which data signals may be successfully received and decoded.

### SUMMARY

The described techniques relate to improved methods, systems, devices, and apparatuses that support techniques for multiplexing data and non-data signals. Generally, aspects of the present disclosure support techniques which enable non-data signals to be aligned and transmitted simultaneously with data signals. In particular, this aspects of the present disclosure may support rules and conditions which enable non-data signals and/or data signals to be modified and aligned so that the respective signals may be transmitted simultaneously. For example, a transmitting (Tx) device may receive scheduling information which schedules a temporally overlapping data signal and a non-data signal (e.g., energy signal, artificial noise signal). In this example, in order to transmit both signals, the Tx device may aligns the starting symbols of the data signal and the non-data signal, and transmit the data and non-data signal based on the alignment. In some cases, the Tx device may modify the data signal and/or the non-data signal, for example, by shortening or lengthening the respective signals.

A method is described. The method may include receiving scheduling information that schedules temporally overlapping transmissions by the wireless device of a data signal and an additional signal, where the additional signal includes an artificial noise signal, an energy signal associated with an energy-harvesting device, or both, aligning a starting symbol of the additional signal with a starting symbol of the data signal based on the data signal and the additional signal being scheduled to temporally overlap, and transmitting the data signal and the additional signal based on the aligning.

An apparatus is described. The apparatus may include at least one processor, memory coupled to the at least one processor, the memory storing instructions executable by the at least one processor to cause the apparatus to receive scheduling information that schedules temporally overlapping transmissions by the wireless device of a data signal and an additional signal, where the additional signal includes an artificial noise signal, an energy signal associated with an energy-harvesting device, or both, align a starting symbol of the additional signal with a starting symbol of the data signal based on the data signal and the additional signal being scheduled to temporally overlap, and transmit the data signal and the additional signal based on the aligning.

Another apparatus is described. The apparatus may include means for receiving scheduling information that schedules temporally overlapping transmissions by the wireless device of a data signal and an additional signal, where the additional signal includes an artificial noise signal, an energy signal associated with an energy-harvesting device, or both, means for aligning a starting symbol of the additional signal with a starting symbol of the data signal based on the data signal and the additional signal being scheduled to temporally overlap, and means for transmitting the data signal and the additional signal based on the aligning.

A non-transitory computer-readable medium storing code is described. The code may include instructions executable by a processor to receive scheduling information that schedules temporally overlapping transmissions by the wireless device of a data signal and an additional signal, where the additional signal includes an artificial noise signal, an energy signal associated with an energy-harvesting device, or both, align a starting symbol of the additional signal with a starting symbol of the data signal based on the data signal and the additional signal being scheduled to temporally overlap, and transmit the data signal and the additional signal based on the aligning.

Some examples of the method, apparatuses, and non-transitory computer-readable medium described herein may further include operations, features, means, or instructions for modifying a length of the data signal such that the data signal includes a first quantity of symbols that may be less than or equal to a second quantity of signals associated with the additional signal, where aligning the starting symbol of the additional signal with the starting symbol of the data signal may be based on the modifying.

Some examples of the method, apparatuses, and non-transitory computer-readable medium described herein may further include operations, features, means, or instructions for modifying a length of the additional signal such that the additional signal and the data signal include equal quantities of symbols, where aligning the starting symbol of the additional signal with the starting symbol of the data signal may be based on the modifying.

Some examples of the method, apparatuses, and non-transitory computer-readable medium described herein may further include operations, features, means, or instructions for transmitting an indication of the modifying to the second wireless device, where transmitting the additional signal may be based on transmitting the indication of the modifying.

In some examples of the method, apparatuses, and non-transitory computer-readable medium described herein, the data signal includes a first quantity of symbols and the additional signal includes a second quantity of symbols that may be greater than the first quantity of symbols.

Some examples of the method, apparatuses, and non-transitory computer-readable medium described herein may further include operations, features, means, or instructions for transmitting the first portion of the additional signal in accordance with a first transmit power and transmitting the second portion of the additional signal in accordance with a second transmit power that may be greater than the first transmit power based on the second portion of the additional signal not temporally overlapping with the data signal.

In some examples of the method, apparatuses, and non-transitory computer-readable medium described herein, the data signal may be transmitted in accordance with a third transmit power and the second transmit power may be based on a sum of the first transmit power and the third transmit power.

Some examples of the method, apparatuses, and non-transitory computer-readable medium described herein may further include operations, features, means, or instructions for communicating a message indicating a difference between the second transmit power and the sum of the first transmit power and the third transmit power.

In some examples of the method, apparatuses, and non-transitory computer-readable medium described herein, the additional signal may be transmitted to a second wireless device and transmitting the second portion of the additional signal in accordance with the second transmit power that may be greater than the first transmit power may be based on a first power level of the wireless device being greater than or equal to a first threshold power level, a first charging rate of the wireless device being greater than or equal to a first threshold charging rate, a second power level of the second wireless device less than or equal to a second threshold power level, a second charging rate of the second wireless device being less than or equal to a second threshold charging rate, or any combination thereof.

Some examples of the method, apparatuses, and non-transitory computer-readable medium described herein may further include operations, features, means, or instructions for modifying a length of the additional signal such that the additional signal and the data signal include equal quantities of symbols, where aligning the starting symbol of the additional signal with the starting symbol of the data signal may be based on the modifying.

Some examples of the method, apparatuses, and non-transitory computer-readable medium described herein may further include operations, features, means, or instructions for transmitting an indication of the modifying to the second wireless device, the third wireless device, or both, where transmitting the data signal, transmitting the additional signal, or both, may be based on transmitting the indication of the modifying.

In some examples of the method, apparatuses, and non-transitory computer-readable medium described herein, data signal may be associated with a first demodulation reference signal (DMRS) pattern and the additional signal may be associated with a second DMRS pattern that may be based on the first DMRS pattern.

Some examples of the method, apparatuses, and non-transitory computer-readable medium described herein may further include operations, features, means, or instructions for modifying a length of the additional signal such that the additional signal includes a same quantity of symbols as the data signal, the second data signal, or both, where aligning the starting symbol of the additional signal with the starting symbol of the data signal may be based on the modifying.

Some examples of the method, apparatuses, and non-transitory computer-readable medium described herein may further include operations, features, means, or instructions for transmitting the data signal and the modified additional signal to a second wireless device and transmitting the second data signal and the modified additional signal to a third wireless device different from the second wireless device.

Some examples of the method, apparatuses, and non-transitory computer-readable medium described herein may further include operations, features, means, or instructions for transmitting a third additional signal to the second wireless device based on the scheduling information, where the third additional signal may be based on the additional signal and the second additional signal.

In some examples of the method, apparatuses, and non-transitory computer-readable medium described herein, the additional signal and the second additional signal may be associated with a first set of parameters and a second set of parameters, respectively, the third additional signal may be associated with a third set of parameters that may be based on the first set of parameters and the second set of parameters, and the first set of parameters, the second set of parameters, the third set of parameters, or any combination thereof, include an allocation size, a transmit power, a target power, a repetition factor, or any combination thereof.

In some examples of the method, apparatuses, and non-transitory computer-readable medium described herein, the additional signal includes the artificial noise signal that may be configured to provide physical layer security for the data signal, an additional data signal, or both, against unintended receiver devices.

Some examples of the method, apparatuses, and non-transitory computer-readable medium described herein may further include operations, features, means, or instructions for transmitting the data signal with a same phase coherency based on aligning the starting symbol of the additional signal with the starting symbol of the data signal.

A method is described. The method may include receiving a data signal and an additional signal, where at least a portion of the data signal temporally overlaps with at least a portion of the additional signal, and where the additional signal includes an artificial noise signal, an energy signal associated with an energy harvesting device, or both, determining a first DMRS pattern associated with the additional signal based on a second DMRS pattern associated with the data signal, filtering the additional signal from the data signal based on the first DMRS pattern associated with the additional signal, and decoding the data signal based on the filtering.

An apparatus is described. The apparatus may include at least one processor, memory coupled to the at least one processor, the memory storing instructions executable by the at least one processor to cause the apparatus to receive a data signal and an additional signal, where at least a portion of the data signal temporally overlaps with at least a portion of the additional signal, and where the additional signal includes an artificial noise signal, an energy signal associated with an energy harvesting device, or both, determine a first DMRS pattern associated with the additional signal based on a second DMRS pattern associated with the data signal, filter the additional signal from the data signal based on the first DMRS pattern associated with the additional signal, and decode the data signal based on the filtering.

Another apparatus is described. The apparatus may include means for receiving a data signal and an additional signal, where at least a portion of the data signal temporally overlaps with at least a portion of the additional signal, and where the additional signal includes an artificial noise signal, an energy signal associated with an energy harvesting device, or both, means for determining a first DMRS pattern associated with the additional signal based on a second DMRS pattern associated with the data signal, means for filtering the additional signal from the data signal based on the first DMRS pattern associated with the additional signal, and means for decoding the data signal based on the filtering.

A non-transitory computer-readable medium storing code is described. The code may include instructions executable by a processor to receive a data signal and an additional signal, where at least a portion of the data signal temporally overlaps with at least a portion of the additional signal, and where the additional signal includes an artificial noise signal, an energy signal associated with an energy harvesting device, or both, determine a first DMRS pattern associated with the additional signal based on a second DMRS pattern associated with the data signal, filter the additional signal from the data signal based on the first DMRS pattern associated with the additional signal, and decode the data signal based on the filtering.

Some examples of the method, apparatuses, and non-transitory computer-readable medium described herein may further include operations, features, means, or instructions for receiving control signaling indicating a mapping configuration for DMRS patterns, where the first DMRS pattern may be determined based on the mapping configuration.

Some examples of the method, apparatuses, and non-transitory computer-readable medium described herein may further include operations, features, means, or instructions for receiving an indication of the second DMRS pattern, where receiving the data signal and determining the first DMRS pattern may be based on receiving the indication of the second DMRS pattern.

Some examples of the method, apparatuses, and non-transitory computer-readable medium described herein may further include operations, features, means, or instructions for receiving scheduling information that schedules the wireless device to receive the data signal and the additional signal from a second wireless device and receiving, from the second wireless device and based on the scheduling information, an indication of a modification of the data signal, the additional signal, or both, where receiving the data signal and the additional signal may be based on receiving the indication of the modification.

In some examples of the method, apparatuses, and non-transitory computer-readable medium described herein, the data signal includes a first quantity of symbols and the additional signal includes a second quantity of symbols that may be greater than the first quantity of symbols.

In some examples of the method, apparatuses, and non-transitory computer-readable medium described herein, the additional signal includes a first portion that temporally overlaps with the data signal and a second portion that does not temporally overlap with the data signal and the method, apparatuses, and non-transitory computer-readable medium may include further operations, features, means, or instructions for receiving the first portion of the additional signal in accordance with a first transmit power and receiving the second portion of the additional signal in accordance with a second transmit power that may be greater than the first transmit power based on the second portion of the additional signal not temporally overlapping with the data signal.

In some examples of the method, apparatuses, and non-transitory computer-readable medium described herein, the data signal may be received in accordance with a third transmit power and the second transmit power may be based on a sum of the first transmit power and the third transmit power.

Some examples of the method, apparatuses, and non-transitory computer-readable medium described herein may further include operations, features, means, or instructions for receiving a message indicating a difference between the second transmit power and the sum of the first transmit power and the third transmit power.

In some examples of the method, apparatuses, and non-transitory computer-readable medium described herein, the additional signal includes the artificial noise signal that may be configured to provide physical layer security for the data signal, an additional data signal, or both, against unintended receiver devices.

Some examples of the method, apparatuses, and non-transitory computer-readable medium described herein may further include operations, features, means, or instructions for decoding the data signal based on the data signal including a same phase coherency across the data signal.

### BRIEF DESCRIPTION OF THE DRAWINGS

FIG. 1 illustrates an example of a wireless communications system that supports techniques for multiplexing data and non-data signals in accordance with one or more aspects of the present disclosure.

FIG. 2 illustrates an example of a wireless communications system that supports techniques for multiplexing data and non-data signals in accordance with one or more aspects of the present disclosure.

FIG. 3 illustrates an example of a resource configuration that supports techniques for multiplexing data and non-data signals in accordance with one or more aspects of the present disclosure.

FIG. 4 illustrates an example of a resource configuration that supports techniques for multiplexing data and non-data signals in accordance with one or more aspects of the present disclosure.

FIG. 5 illustrates an example of resource configurations that support techniques for multiplexing data and non-data signals in accordance with one or more aspects of the present disclosure.

FIG. 6 illustrates an example of a resource configuration that supports techniques for multiplexing data and non-data signals in accordance with one or more aspects of the present disclosure.

FIG. 7 illustrates an example of a process flow that supports techniques for multiplexing data and non-data signals in accordance with one or more aspects of the present disclosure.

FIGS. 8 and 9 show block diagrams of devices that support techniques for multiplexing data and non-data signals in accordance with one or more aspects of the present disclosure.

FIG. 10 shows a block diagram of a communications manager that supports techniques for multiplexing data and non-data signals in accordance with one or more aspects of the present disclosure.

FIG. 11 shows a diagram of a system including a device that supports techniques for multiplexing data and non-data signals in accordance with one or more aspects of the present disclosure.

FIGS. 12 through 15 show flowcharts illustrating methods that support techniques for multiplexing data and non-data signals in accordance with one or more aspects of the present disclosure.

### DETAILED DESCRIPTION

Some wireless communications systems facilitate communication of different types of signals, including data signals and non-data signals. Data signals may include information that is to be decoded by the receiver, such as control channel and/or shared channel communications. Comparatively, non-data signals may not include any information that is to be decoded by the receiver, and may include energy signals, artificial noise signals, or both. For example, some passive devices (e.g., passive radio frequency identifier (RFID) tags) may not include a separate power source, and may instead receive and absorb power used to perform communications and other operations from energy signals (e.g., non-data signals) received from other devices. In some implementations, artificial noise signals may be used to “protect” data signals from being decoded by unintended receivers.

However, the presence of non-data signals may detrimentally affect the transmission of data signals within wireless communications systems, and detrimentally affect the reliability with which data signals may be successfully received and decoded. For example, in cases where non-data signals transmitted by a wireless device temporally overlap with only a portion of a data signal also transmitted by the wireless device, the data signal may not exhibit phase continuity across the entirety of the data signal (due to the wireless device turning on or off the transmission of the non-data signal while in the middle of the transmission of the data signal), thereby complicating the ability of the data signal to be decoded at the receiver.

Accordingly, aspects of the present disclosure are directed to techniques which enable non-data signals to be aligned and transmitted simultaneously with data signals. In particular, aspects of the present disclosure are directed to rules and conditions which enable non-data signals and/or data signals to be modified and aligned so that the respective signals may be transmitted simultaneously. For example, a transmitting (Tx) device may receive scheduling information which schedules the Tx device to transmit a data signal and a temporally overlapping non-data signal (e.g., energy signal, artificial noise signal) to a receiving (Rx) device. In this example, in order to transmit both signals, the Tx device may align (or shift) the starting symbols of the data signal and the non-data signal, and may transmit the data signal and the temporally overlapping non-data signal based on the alignment.

In some implementations, the Tx device may modify the data signal and/or the non-data signal. For instance, the Tx device may shorten the data signal to be the same length as the non-data signal. Similarly, the Tx device may shorten or lengthen the non-data signal to be the same length as the data signal. In some aspects, the Rx device may utilize a demodulation reference signal (DMRS) pattern of the data signal to determine the DMRS pattern of the non-data signal. As such, the Rx device may determine the DMRS pattern of the non-data signal based on the DMRS pattern of the data signal in order to filter out the non-data signal and decode the data signal.

Aspects of the disclosure are initially described in the context of wireless communications systems. Additional aspects of the disclosure are described in the context of example resource configurations and an example process flow Aspects of the disclosure are further illustrated by and described with reference to apparatus diagrams, system diagrams, and flowcharts that relate to techniques for multiplexing data and non-data signals.

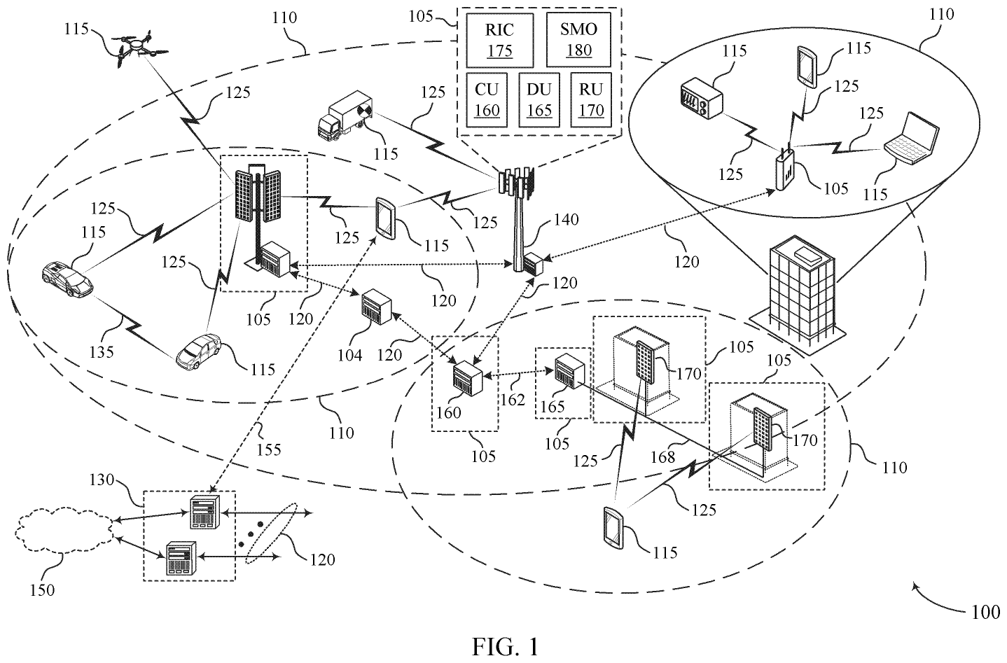

FIG. 1 illustrates an example of a wireless communications system 100 that supports techniques for multiplexing data and non-data signals in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for multiplexing data and non-data signals as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of T_{S}=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some aspects, the wireless communications system 100 may support techniques which enable non-data signals to be aligned and transmitted simultaneously with data signals. In particular, the wireless communications system 100 may support rules and conditions which enable non-data signals and/or data signals to be modified and aligned so that the respective signals may be transmitted simultaneously.

For example, a Tx device (e.g., first UE 115-) of the wireless communications system 100 may receive scheduling information which schedules the Tx device to transmit a data signal and a temporally overlapping non-data signal (e.g., energy signal, artificial noise signal) to an Rx device (e.g., second UE 115). In this example, in order to transmit both signals, the Tx device may align (or shift) the starting symbols of the data signal and the non-data signal, and may transmit the data signal and the temporally overlapping non-data signal based on the alignment.

In some implementations, the Tx device may modify the data signal and/or the non-data signal. For instance, the Tx device may shorten the data signal to be the same length as the non-data signal. Similarly, the Tx device may shorten or lengthen the non-data signal to be the same length as the data signal. In some aspects, the Rx device may utilize a DMRS pattern of the data signal to determine the DMRS pattern of the non-data signal. As such, the Rx device may determine the DMRS pattern of the non-data signal based on the DMRS pattern of the data signal in order to filter out the non-data signal and decode the data signal.

Techniques described herein may enable wireless devices to efficiently and effectively transmit data signals and temporally overlapping non-data signals, such as energy signals and artificial noise signals. In particular, aspects of the present disclosure may enable non-data signals to be transmitted simultaneously with data signals in order to facilitate energy harvesting processes for energy harvesting devices, provide physical layer protection for the data signals, or both. Moreover, the rules and configurations of the present disclosure may enable non-data signals to be simultaneously transmitted along with data signals in such a manner as to reduce or eliminate detrimental effects of the non-data signals at Rx devices. As such, aspects of the present disclosure may improve an efficiency and reliability of wireless communications within the wireless communications system.

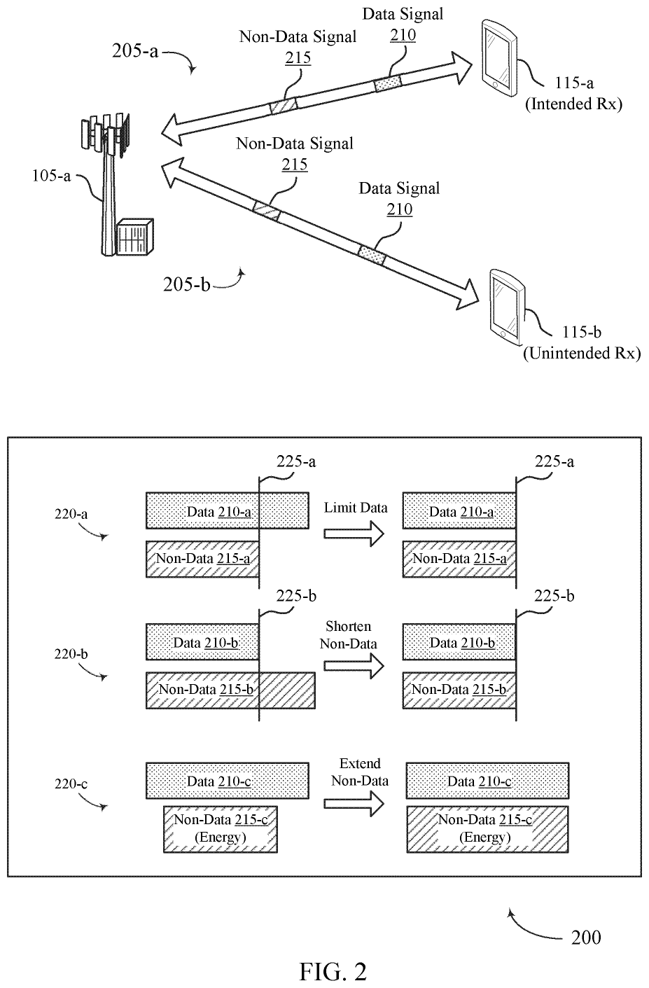

FIG. 2 illustrates an example of a wireless communications system 200 that supports techniques for multiplexing data and non-data signals in accordance with one or more aspects of the present disclosure. In some examples, aspects of the wireless communications system 200 may implement, or be implemented by, aspects of the wireless communications system 100. In particular, the wireless communications system 200 may support signaling, configurations, and other mechanisms which enable non-data signals to be aligned and transmitted simultaneously with data signals, as described with respect to FIG. 1.

The wireless communications system 200 may include a network entity 105-a, a first UE 115-a (e.g., “intended” UE 115-a or Rx device), and a second UE 115-b (e.g., “unintended” UE 115-b or Rx device, or “eavesdropper” UE 115-b), which may be examples of wireless devices as described with reference to FIG. 1. The in some aspects, the UEs 115-a, 115-b may communicate with the network entity 105-a using communication links 205-a and 205-b, respectively, which may be examples of NR or LTE links between the respective UEs 115 and the network entity 105-a. In some cases, the communication links 205 may include examples of access links (e.g., Uu links) which may include bi-directional links that enable both uplink and downlink communication. For example, the first UE 115-a may transmit uplink signals, such as uplink control signals or uplink data signals, to one or more components of the network entity 105-a using the communication link 205-a, and one or more components of the network entity 105-a may transmit downlink signals, such as downlink control signals or downlink data signals, to the first UE 115-a using the communication link 205-a.

In some implementations, the wireless communications system 200 may include one or more passive devices. Passive devices may include lower-complexity devices (e.g., <100 μW devices) including, but not limited to, RFID tags, passive IoT devices, hybrid devices including passive and active components, passive components of otherwise active/querying devices (e.g., passive components of a UE 115), or any combination thereof. For example, in some implementations, the first UE 115-a, the second UE 115-b, or both, of the wireless communications system 200 may serve as passive devices.

Passive devices may be implemented in the wireless communications system 200 to support various services and applications, such as identification, tracking, sensing, and the like. Other use cases that may be supported or facilitated by the passive devices may include power sourcing, security applications, access control or access connectivity management, positioning services, and the like. Passive devices may be capable of communicating over different frequency ranges, such as UHF ranges.

To communicate with a passive device, a querying or Tx device (e.g., network entity 105, UE 115) may transmit a signal or query to the passive device to instruct the passive device to perform a read or write operation. Passive devices such as RFID tags may include relatively low-complexity devices with limited resources and processing power, and may therefore perform a limited number of read or write operations at a time. A writing operation may include one-way signaling from the querying/Tx device to the passive device to configure or adjust parameters of the passive device. Comparatively, a reading operation may include two-way signaling between the querying/Tx device and the passive device in which the querying device transmits a query or message, and receives or “reads” some responsive signaling back from the passive device. In some aspects, passive devices may include battery-less or limited energy storage (e.g., capacitor) devices capable of wireless communication. For example, in some cases, the passive devices may support Energy Harvesting Enabled Communication Services (EHECS) in 5GS.

In some implementations, passive devices may include relatively low-complexity devices which may or may not include a power amplifier and/or a battery. In some cases, passive devices may include antennas (e.g., dipole antennas) and other circuitry (e.g., integrated circuit, chip, load) used to facilitate wireless communications. In some aspects, the range over which a passive device can transmit a message (e.g., backscattered signal) may depend on the manner in which the respective passive device is powered. For example, in some cases, a passive device may not include a power source, but may instead receive power from wireless communications received from querying devices and may transmit far-field signals or modulate reflected signals using power absorbed or extracted from signals received from querying devices.

In some aspects, passive devices may receive or generate power used for wireless communications and other operations using a rectifier, where a rectifier may include a diode and a capacitor. For example, a passive device may receive a signal from a Tx device (e.g., network entity 105-a) via an antenna, where power absorbed from the antenna is directed to a power rectifier. In this example, the power rectifier converts absorbed power from the antenna to rectified power, which may be directed back to the antenna to transmit messages (e.g., transmit backscattered signals). In some cases, a power rectifier may exhibit an energy conservation efficiency of approximately thirty percent.

In this regard, in the context of an energy harvesting process, a Tx device may transmit an energy signal (e.g., non-data signal 215) to a passive device, where the passive device is configured to utilize (and/or store) power extracted from the energy signal to perform wireless communications and other applications/operations. As such, non-data signals 215 (e.g., signals that do not include data that is intended to be decoded) may be used to facilitate applications and other communications enabled by passive devices.

The wireless communications system 200 may use other types of non-data signals 320 in addition to energy signals used for energy-harvesting by passive devices. In particular, artificial noise signals (another type of non-data signals) may be used to improve physical layer security within the wireless communications system. Artificial noise signals (based on a secret key) may be transmitted with other data signals 210, where the artificial noise is intended to degrade SINR of the data signal 210 at unintended receivers.

For example, when transmitting a data signal 210 to the first UE 115-a, the network entity 105-a may be configured to also transmit a non-data signal 215 (e.g., artificial noise signal), to degrade an ability of the second UE 115-b (e.g., an unintended or eavesdropper UE 115) to receive and decode the data signal 210. In this example, the non-data signal 215 may be added (based on a secret key) to each resource element of the data signal 210 (or added as common noise across sets of resource elements of the data signal 210). The first UE 115-a (e.g., the intended UE 115-a) may be able to filter out the non-data signal 215 and reconstruct the non-data signal 215 based on the secret key, and can therefore filter out (e.g., cancel out) the non-data signal 215 from the data signal 210 before decoding the data signal 210. Comparatively, without the secret key, the second UE 115-b (e.g., the unintended UE 115-b) may be unable to filter out the non-data signal 215 to decode the data signal 210, thereby improving physical layer security of the data signal 210.

Secret keys for non-data signals may be determined or generated according to different implementations, such as through upper layer techniques using Diffie-Hellman which relies on Rivest-Shamir-Adleman techniques, other symmetric key methods relying on Elliptic Curve Cryptography (ECC), or other techniques. In additional or alternative implementations, secret keys for non-data signals 215 may be determined or generated by leveraging channel reciprocity and randomness of the physical layer.

With increasing quantities of energy-harvesting devices (e.g., passive devices) being implemented in wireless communications systems, and with an increasing desire to improve physical layer security, the use of non-data signals 215 (e.g., energy signals, artificial noise signals) may become more widespread. Specifically, energy signals may be used for energy-harvesting processes used to power passive devices (e.g., UEs 115, power cells, RFID tags), and artificial noise signals may be used to degrade SINR of data signals 210 at unintended Rx devices to improve physical layer security.

However, the presence of non-data signals 215 may detrimentally affect the transmission of data signals 210 within the wireless communications system 200, and detrimentally affect the reliability with which data signals 210 may be successfully received and decoded. For example, in cases where non-data signals 215 transmitted by a wireless device temporally overlap with only a portion of a data signal 210 also transmitted by the wireless device, the data signal 210 may not exhibit phase continuity across the entirety of the data signal 210 (due to the wireless device turning on or off the transmission of the non-data signal 215 while in the middle of the transmission of the data signal 210), thereby complicating the ability of the data signal 210 to be decoded at the receiver.

Accordingly, aspects of the present disclosure are directed to techniques which enable non-data signals 215 to be aligned and transmitted simultaneously with data signals 210. In particular, the wireless communications system 200 may support rules and conditions which enable non-data signals 215 (e.g., energy signals, artificial noise signals) and/or data signals 210 to be modified and aligned so that the respective signals may be multiplexed and transmitted simultaneously.

For example, referring to the wireless communications system 100, the network entity 105-a may transmit, to the first UE 115-a, control signaling indicating scheduling information for a data signal 210 and non-data signal 215 to be transmitted from the network entity 105-a to the first UE 115-a. For example, the first UE 115-a may receive scheduling information that schedules the first UE 115-a to receive, from the network entity 105-a, temporally overlapping transmissions of a data signal 210 and a non-data signal 215, such as an energy signal or an artificial noise signal.

As described previously herein, the data signal 210 may include data that is intended to be decoded by the intended Rx device. Comparatively, the non-data signal 215 may not include any data that is intended to be decoded by the respective Rx devices. The non-data signal 215 may include an energy signal associated with an energy-harvesting device (e.g., passive device such as an RFID tag), an artificial noise signal intended to provide physical layer security or protection for the scheduled data signal 210 or another data signal 210, or both.

In some implementations, the scheduling information may indicate a DMRS pattern associated with the data signal 210, the non-data signal 215, or both. Additionally, or alternatively, the scheduling information may indicate a secret key that may be utilized to transmit and filter out the non-data signal 215 from the temporally overlapping data signal 210.

In some implementations, the network entity 105-a may modify a length of the data signal 210, the non-data signal 215, or both. In particular, the network entity 105-a may modify a length of the data signal 210 and/or the non-data signal 215 based on the data signal 210 and the non-data signal 215 at least partially overlapping in the time domain. In this regard, the network entity 105-a may modify the length of the data signal 210 and/or the non-data signal 215 based on the scheduling information for the respective signals.

In cases where the non-data signal 215 is shorter than the data signal 210, the differing lengths of the respective signals may result in power amplifier phase changes on the Tx side (e.g., power amplifier changes at the network entity 105-a), which may result in the data signal 210 not exhibiting phase coherency across the entirety of the data signal 210, thereby resulting in complications on the Rx side.

For example, referring to a first resource configuration 220-a, the network entity 105-a may be scheduled to transmit a data signal 210-a and a non-data signal 215-a, where the non-data signal 215-a is shorter than the data signal 210-a in the time domain. In this regard, the data signal 210-a extends beyond an end 225-a of the non-data signal 215-a. In this example, on the Tx side (e.g., at the network entity 105-a), a power amplifier may exhibit a phase change at the end 225-a as the network entity 105-a transitions from transmitting both the data signal 210-a and the non-data signal 215-a to transmitting only the data signal 210-a. Such a power amplifier phase change may cause the data signal 210-a not exhibiting phase coherency across the entirety of the data signal 210-a. In particular, a first portion of the data signal 210-a prior to the end 225-a may exhibit a first phase, and a second portion of the data signal 210-a after the end 225-a may exhibit a second phase that is incoherent with (e.g., not the same as) the first phase. Such phase changes may result in complications with decoding the data signal 210-a at the Rx side (e.g., at the first UE 115-a).

Accordingly, in some implementations, non-data signals 215 (e.g., energy or artificial noise) and data signals 210 may be modified or scheduled to include the same number of OFDM symbols so that the power amplifier does not change phase which might cause phase incoherently for the data signal 210. In other words, in some implementations, the network entity 105-a (or other Tx device, such as a UE 115) may modify a length of the data signal 210 and/or the data signal 210 in order to avoid power amplifier phase changes within the data signal 210.

For example, referring to the first resource configuration 220-a, the network entity 105-a may be configured to restrict the number of symbols of the data signal 210 to be the same as number of symbols of the non-data signal 215. In other words, if the network entity 105-a receives a request or order to transmit the non-data signal 215-a with a size that is smaller than the data signal 210, the network entity 105-a may restrict the size (e.g., quantity of symbols) of the data signal 210-a. For instance, as shown in the first resource configuration 220-a, the network entity 105-a may restrict or limit the size of the data signal 210-a (e.g., shorten the data signal 210-a) so that the data signal 210-a and the non-data signal 215-a exhibit the same length in the time domain.

In other cases, a Tx device (e.g., network entity 105-a) may be configured to shorten a non-data signal 215 in cases where the scheduled non-data signal 215 is longer than the data signal 210. For example, referring to the second resource configuration 220-b, the network entity 105-a may be scheduled to transmit a data signal 210-b and a non-data signal 215-b, where the non-data signal 215-b is longer than the data signal 210-b in the time domain. In this regard, the non-data signal 215-b may extend beyond and end 225-b of the data signal 210-b in the time domain. In this example, the network entity 105-a may shorten the non-data signal 215-b so that the data signal 210-b and the non-data signal 215-b are the same length (e.g., include the same quantity of symbols).

Moreover, in some cases, a Tx device (e.g., UE 115, network entity 105-a) may be configured to extend (e.g., lengthen) non-data signals 215 so that the respective non-data signal 215 is longer than, or the same length as, the respective data signal 210. For example, referring to the third resource configuration 220-c, the network entity 105-a may be scheduled to transmit a data signal 210-c and a non-data signal 215-c (e.g., energy signal), where the non-data signal 215-c is shorter than the data signal 210-c. In this example, the network entity 105-a may be configured to extend the energy signal (e.g., non-data signal 215-c) in the time domain so that the non-data signal 215-c is the same length as the data signal 210-c.

In some cases, a Tx device (e.g., network entity 105-a, UE 115-a) may not be configured to modify a length of either the data signal 210 or the non-data signal 215. For example, in cases where the non-data signal 215 (e.g., energy signal, artificial noise signal) is longer than the data signal 210, this may not result in any phase coherency issues with respect to the data signal 210. For example, referring to the second resource configuration 220-b, because the data signal 210-b is shorter than the non-data signal 215-b, the non-data signal 215-b may exhibit different phases before and after the end 225-b of the data signal 210-b. However, because the non-data signal 215-b does not include any actual data that is to be decoded by the Rx device, the non-phase coherency of the non-data signal 215-b may not result in any issues at the Rx device. As such, in this example, the Tx device may refrain from shortening the non-data signal 215-b.

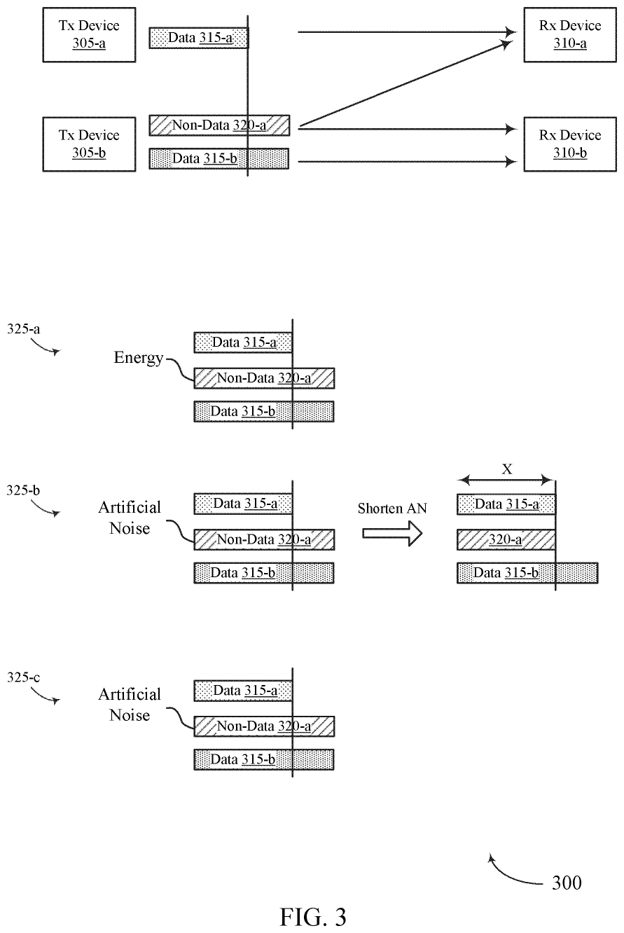

Different techniques, rules, and conditions for modifying a length of a data signal 210 and/or a non-data signal 215 will be described in further detail with respect to FIGS. 3-6.

In some aspects, upon modifying a length of the data signal 210 and/or the non-data signal 215, a Tx device (e.g., network entity 105-a, UE 115) may be configured to indicate the modification to the intended Rx device(s). For example, referring to the third resource configuration 220-c, upon extending the length of the non-data signal 215-c, the network entity 105-a may indicate the modification (e.g., via Layer 1 (L1) signaling, Layer 2 (L2) signaling, Layer 3 (L3) signaling) to intended Rx devices for the data signal 210-c and/or the non-data signal 215-c so that the respective Rx devices are able to filter out or cancel the non-data signal 215-c (e.g., energy signal) and harvest the non-data signal 215-c, respectively.

In some aspects, the Tx device (e.g., network entity 105-a) may align the data signal 210 and the non-data signal 215. In particular, the network entity 105-a may align a starting symbol of the data signal 210 and a starting symbol of the non-data signal 215. The network entity 105-a may align the data signal 210 and the non-data signal 215 based on the respective signals being scheduled to at least temporally overlap. Moreover, the network entity 105-a may perform the alignment based on modifying the length of the data signal 210 and/or the non-data signal 215 (e.g., align the modified lengths of the data signal 210 and/or the non-data signal 215). For example, as shown in the third resource configuration 220-c, the Tx device (e.g., network entity 105-a) may lengthen the non-data signal 215-c, and align the starting symbols of the data signal 210-c and the non-data signal 215-c based on extending the length of the non-data signal 215-c.

Subsequently, the Tx device (e.g., network entity 105-a) may transmit the temporally overlapping data signal 210 and non-data signal 215. As described previously herein, the data signal 210 and the non-data signal 215 may at least partially overlap in the time domain. In particular, the first wireless device 705-a may transmit the data signal 210 and the non-data signal 215 to the first UE 115-a based on the scheduling information and aligning the respective signals. In this regard, the network entity 105-a may transmit the data signal 210 and the non-data signal 215 based on the scheduling information for the respective signals, modifying the length of the data signal 210 and/or the non-data signal 215, aligning the data signal 210 and the non-data signal 215, or any combination thereof.

The network entity 105-a may be configured to transmit the data signal 210 and/or the non-data signal 215 in accordance with the scheduling information and the indicated parameters of the respective signals, including the respective DMRS patterns, the respective transmit powers, and the like.

In some aspects, the Rx device (e.g., first UE 115-a) may determine a DMRS pattern of the data signal 210. In some implementations, the first UE 115-a may determine the DMRS pattern of the data signal 210 based on the original scheduling information, based on other signaling from the network entity 105-a or another wireless device, or any combination thereof. Moreover, the Rx device (e.g., first UE 115-a) may determine a DMRS pattern of the non-data signal 215.

In some aspects, the first UE 115-a may determine the DMRS pattern of the non-data signal 215 in accordance with a DMRS mapping configuration for DMRS patterns. In particular, the first UE 115-a may map the DMRS pattern of the data signal 210 to the DMRS pattern of the non-data signal 215 in accordance with a DMRS mapping configuration. In such cases, the DMRS mapping configuration may be configured at the first UE 115-a, signaled to the first UE 115-a by the network entity 105-a (e.g., via RRC signaling), signaled to the first UE 115-a by another wireless device, or any combination thereof.

For example, the Rx device may be configured to determine a DMRS pattern of the data signal 210, and may be configured to determine a DMRS pattern of the non-data signal 215 using a DMRS mapping configuration or other procedure based on the non-data signal 215 overlapping with the data signal 210. For instance, if the DMRS pattern or scrambling ID for the data signal 210 is X, then the DMRS pattern or scrambling ID for the non-data signal 215 may be determined to be Y according to a DMRS mapping configuration (e.g., mapping configuration that maps DMRS pattern X to DMRS pattern Y). In some aspects, the energy DMRS signal can be less dense, based on density of data.

In some aspects, the DMRS pattern of the data signal 210 and the DMRS pattern of the non-data signal 215 (e.g., energy signal) may be expected to have different DMRS IDs or cyclic shifts when the data signal 210 and the non-data signal 215 overlap in the time domain. Comparatively, when the data signal 210 and the non-data signal 215 are associated with different ports, the data signal 210 and the non-data signal 215 may be associated with DMRS patterns with the same DMRS ID. In some aspects, offsets in configurations or relationships between DMRS patterns/configurations (e.g., DMRS mapping configuration) can be signaled using control signaling, such as RRC signaling, MAC-CE signaling, DCI signaling, and the like.

Subsequently, the Rx device (e.g., the first UE 115-a) may filter the non-data signal 215 from the data signal 210. In other words, the first UE 115-a may be configured to receive signal energy including the data signal 210 and the non-data signal 215, identify a portion of the signal energy that is attributable to the non-data signal 215, and filter or cancel out the portion of the signal energy that is attributable to the non-data signal 215. In some aspects, the first UE 115-a may filter out the non-data signal 215 from the data signal 210 based on the DMRS pattern of the non-data signal 215, the DMRS pattern of the data signal 210, or both. For example, the non-data signal 215 may include DMRS tones (e.g., a DMRS pattern) so that the intended Rx device (e.g., first UE 115-a) can cancel out the non-data signal 215 using non-data signal construction and cancellation.

In this regard, the first UE 115-a may filter out the non-data signal 215 based on receiving the scheduling information for the respective signals, determining the DMRS pattern of the data signal 210, determining the DMRS pattern of the non-data signal 215, receiving the data signal 210 and the non-data signal 215, or any combination thereof. In some aspects, the Rx device (e.g., the first UE 115-a) may decode the data signal 210. In particular, the first UE 115-a may decode the data signal 210 based on filtering out (e.g., canceling out) the non-data signal 215 from the data signal 210.

Techniques described herein may enable wireless devices to efficiently and effectively transmit data signals 210 and temporally overlapping non-data signals 215, such as energy signals and artificial noise signals. In particular, aspects of the present disclosure may enable non-data signals 215 to be transmitted simultaneously with data signals 210 in order to facilitate energy harvesting processes for energy harvesting devices, provide physical layer protection for the data signals 210, or both. Moreover, the rules and configurations of the present disclosure may enable non-data signals 215 to be simultaneously transmitted along with data signals 210 in such a manner as to reduce or eliminate detrimental effects of the non-data signals 215 at Rx devices. As such, aspects of the present disclosure may improve an efficiency and reliability of wireless communications within the wireless communications system.

FIG. 3 illustrates an example of a resource configuration 300 that supports techniques for multiplexing data and non-data signals in accordance with one or more aspects of the present disclosure. In some examples, aspects of the resource configuration 600 may implement, or be implemented by, aspects of the wireless communications system 100, the wireless communications system 200, or both.

As shown in FIG. 3, a wireless communications system (e.g., wireless communications systems 100, 200) may include a first Tx device 305-a, a second Tx device 305-b, a first Rx device 310-a, and a second Rx device 310-b. the Tx devices 305 and Rx devices 310 may include examples of wireless devices as described herein, such as UEs 115, network entities 105, IAB nodes, and the like. In this example, the first Tx device 305-a may be scheduled to transmit a first data signal 315-a to the first Rx device 310-a. Similarly, the second Tx device 305-b may be scheduled to transmit a second data signal 315-b to the second Rx device 310-b. Moreover, the second Tx device 305-b may be scheduled to transmit a non-data signal 320-a (e.g., energy signal, artificial noise signal) to the first Rx device 310-a and the second Rx device 310-b. As shown in FIG. 3, the first data signal 315-a, the second data signal 315-b, and the non-data signal 320-a may all at least partially overlap with one another in the time domain. Further, as shown in FIG. 3, the non-data signal 320-a, the second data signal 315-b, or both, may be longer than the first data signal 315-a in the time domain.

In some cases, the non-data signal 320-a may include an energy signal associated with an energy-harvesting device, such as the first Rx device 310-a and/or the second Rx device 310-b. Additionally, or alternatively, the non-data signal 320-b may include an artificial noise signal that is intended to provide physical layer protection for the first data signal 315-a and/or the second data signal 315-b.

As described previously herein, the first Tx device 305-a, the second Tx device 305-b, or both, may be configured to modify a length of one of the respective signals based on the respective signals at least partially overlapping in the time domain. In some cases, rules or conditions for modifying data signals 315 and/or non-data signals 320 may be based on the type of non-data signal 320 at issue.

For example, if a non-data signal 320 includes an energy signal, it may be okay for the size or length of the energy signal (e.g., quantity of symbols) to be larger than the size or length of the data signal 315 since phase continuity is not important for non-data signals 320. For example, referring to a first resource configuration 325-a, the first data signal 315-a may be shorter than the energy signal (e.g., non-data signal 320-a) and the second data signal 315-b. In this example, the non-data signal 320-b may not exhibit phase coherency across the entirety of the non-data signal 320-b due to a power amplifier phase change that may take place at the end of the transmission of the first data signal 315-a. However, because the non-data signal 320-b does not have any data that will actually be decoded, phase continuity (e.g., phase coherency) may not be expected or required. As such, in this example, the second Tx device 305-b may refrain from shortening the length of the non-data signal 320-a.

Comparatively, in cases where the non-data signal 320 that is longer than the first data signal 315-a includes an artificial noise signal, the second Tx device 305-b may have several options for modifying and aligning the respective signals.

For example, referring to the second resource configuration 325-b, the first data signal 315-a may be shorter than the artificial noise signal (e.g., non-data signal 320-a) and the second data signal 315-b. In this example, the second Tx device 305-b may shorten the non-data signal 320-b (e.g., artificial noise signal) to be the same length as the first data signal 315-a. In such cases, the second Tx device 305-b may inform the second Rx device 310-b (e.g., the intended receiver of the second data signal 315-b) that the artificial noise signal will only overlap with X number of symbols of the second data signal 315-b. In other words, in cases where the non-data signal 320-a is configured to provide physical layer protection or security for the second data signal 315-b, the second Tx device 305-b may indicate, to the second Rx device 310-b, that only the first X number of symbols will be protected.

By way of another example, referring to the third resource configuration 325-c, the first data signal 315-a may be shorter than the artificial noise signal (e.g., non-data signal 320-a) and the second data signal 315-b. In this example, the second Tx device 305-b may refrain from shortening the non-data signal 320-a, as described with respect to the first resource configuration 325-a. In particular, because phase continuity is not required for the non-data signal 320-a, it may be okay that the non-data signal 320-a is longer than the first data signal 315-a.

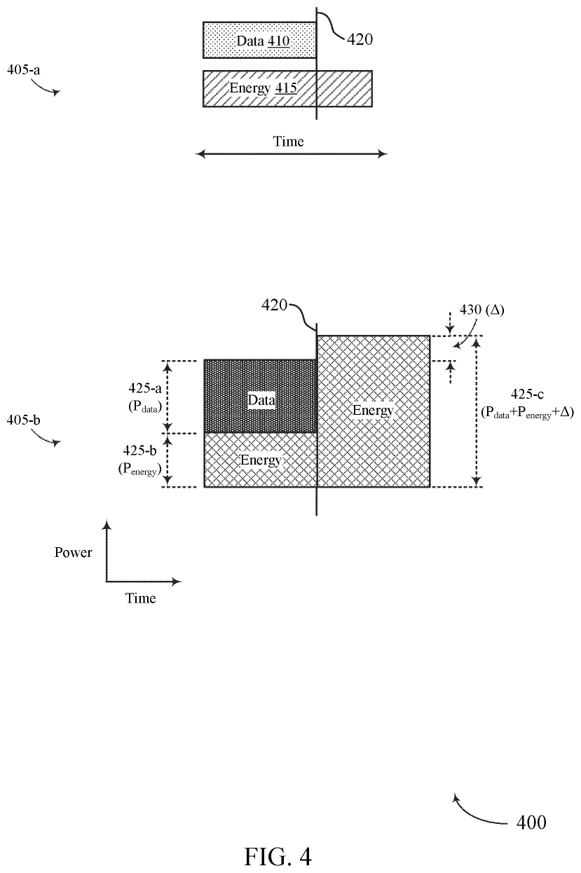

FIG. 4 illustrates an example of a resource configuration 400 that supports techniques for multiplexing data and non-data signals in accordance with one or more aspects of the present disclosure. In some examples, aspects of the resource configuration 400 may implement, or be implemented by, aspects of the wireless communications system 100, the wireless communications system 200, the resource configurations 300-300, or any combination thereof.

In some cases, a Tx device may be scheduled to transmit an energy signal (e.g., non-data signal) and a data signal, where the energy signal is longer than the data signal in the time domain. In such cases, the Tx device may be configured to modify (e.g., increase) a transmit power of a portion of the energy signal that is longer than the data signal to increase the energy/power provided to an Rx device (e.g., an energy-harvesting device) scheduled to receive the energy signal.

For example, as shown in the configuration 405-a, a Tx device may be scheduled to transmit a data signal 410 and an energy signal 415 (e.g., non-data signal), where the data signal 410 and the energy signal 415 at least partially overlap in the time domain. For instance, as shown in FIG. 4, the Tx device may align starting symbols of the respective signals in the time domain. In this example, the energy signal 415 may be longer than the data signal 410 in the time domain such that the energy signal 415 extends beyond an end 420 of the data signal 410.

In this example where the energy signal 415 is longer, the Tx device may increase the transmit power of the energy signal 415 during the remaining part of the energy signal 415 (e.g., for the portion of the energy signal 415 that extends beyond the end 420 of the data signal 410) so that the energy-harvesting device scheduled to receive the energy signal can receive or extract more energy from the energy signal 415.

For instance, referring to the configuration 405-b, the Tx device may be configured to transmit the data signal 410 according to a first transmit power 425-a (P_{data}), and may transmit a first portion of the energy signal 415 that overlaps with the data signal 410 according to a second transmit power 425-b (P_{energy}). In this example, the Tx device may be configured to transmit a second portion of the energy signal 415 (e.g., portion of the energy signal 415 that extends beyond the end 420 of the data signal 410) according to a third transmit power 425-c. In this example, the third transmit power 425-c may be based on the first transmit power 425-a, the second transmit power 425-b, a delta transmit power 430 (Δ), or any combination thereof. For instance, as shown in FIG. 4, the third transmit power 425-c may include a sum of the first transmit power 425-a, the second transmit power 425-b, and the delta transmit power 430 (Δ), where the delta transmit power may include a positive or negative value (e.g., third transmit power 425-c equals P_{data}+P_{energy}−Δ).

In some implementations, the delta transmit power 430 (e.g., +Δ, or −Δ) relative to sum of the first transmit power 425-a and the second transmit power 425-b may be configured at the Tx device and/or the Rx device, signaled to the Tx device and/or the Rx device (e.g., via Layer 1 signaling, Layer 2 signaling, Layer 3 signaling), or any combination thereof. For example, in cases where the Tx device increases the transmit power 425 of the second portion of the energy signal 415 that extends beyond the end 420 of the data signal 410, the Tx device may indicate the adjusted transmit power 425-c to the intended Rx device so that the Rx device (e.g., energy-harvesting device) keeps energy-harvesting circuitry in an active state.

In some aspects, the Tx device may adjust (or refrain from adjusting) the transmit power 425 of the energy signal 415 based on one or more parameters or conditions associated with the Tx device, the Rx device, network conditions, or any combination thereof. In other words, the Tx device may increase the transmit power 425 of the energy signal 415 if certain conditions or thresholds are satisfied. Parameters or conditions that may be used to determine whether (or how) the Tx device is expected to modify the transmit power of the energy signal 415 may include, but are not limited to, a power level of the Tx device, a power level of the Rx device, a charging rate of the Tx device, a charging rate of the Rx device, or any combination thereof.

For example, if the battery level (e.g., power level) and/or charging of the Tx device is high, the Tx device may increase the transmit power 425-c (e.g., third transmit power 425-c) of the energy signal 415 following the end 420 of the data signal 410. In this regard, the Tx device may increase the transmit power 425-a for unused resources after the end of the shorter data signal 410 if the charging rate of the Tx device is greater than or equal to a threshold charging rate, if the power level of the Tx device is greater than or equal to a threshold power level, or both. Similarly, the Tx device may increase the transmit power 425-c (e.g., third transmit power 425-c) of the energy signal 415 following the end 420 of the data signal 410 in conditions where the Rx device exhibits a low charging rate and/or low power level. In this regard, the Tx device may increase the transmit power 425-a for unused resources after the end of the shorter data signal 410 if the charging rate of the Rx device is less than or equal to a threshold charging rate, if the power level of the Rx device is less than or equal to a threshold power level, or both.

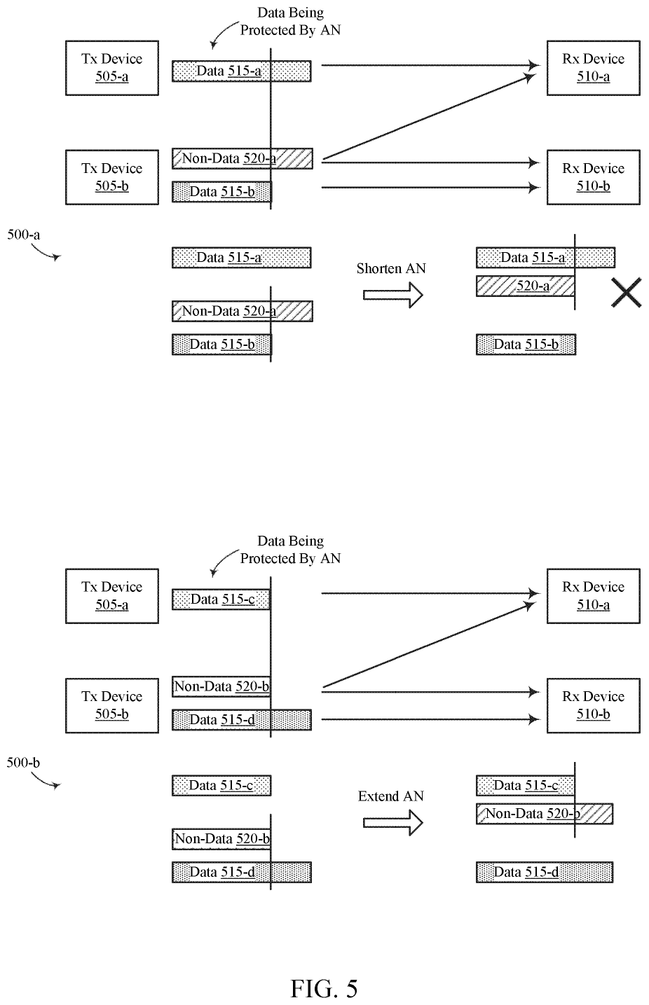

FIG. 5 illustrates examples of resource configurations 500-a, 500-b that support techniques for multiplexing data and non-data signals in accordance with one or more aspects of the present disclosure. In some examples, aspects of the resource configurations 500 may implement, or be implemented by, aspects of the wireless communications system 100, the wireless communications system 200, the resource configurations 300-400, or any combination thereof.

As shown in the first resource configuration 500-a, a wireless

communications system (e.g., wireless communications systems 100, 200) may include a first Tx device 505-a, a second Tx device 505-b, a first Rx device 510-a, and a second Rx device 510-b. the Tx devices 505 and Rx devices 510 may include examples of wireless devices as described herein, such as UEs 115, network entities 105, IAB nodes, and the like. In this example, the first Tx device 505-a may be scheduled to transmit a first data signal 515-a to the first Rx device 510-a. Similarly, the second Tx device 505-b may be scheduled to transmit a second data signal 515-b to the second Rx device 510-b. Moreover, the second Tx device 505-b may be scheduled to transmit a non-data signal 520-a to the first Rx device 510-a and the second Rx device 510-b. As shown in the first resource configuration 500-a, the first data signal 515-a, the second data signal 315-b, and the non-data signal 520-a may all at least partially overlap with one another in the time domain. Further, as shown in FIG. 5, the second data signal 515-b, may be shorter than the first data signal 515-a and the non-data signal 520-a in the time domain.

In some cases, the non-data signal 520-a may include an artificial noise signal (with size X) that serves as an energy signal for one Rx device 510, and provides physical layer security/protection for a data signal 515 transmitted to another Rx device 510. For example, the non-data signal 520-a may serve as an energy signal for an energy-harvesting procedure at the second Rx device 510-b, and may provide physical layer protection for the first data signal 515-a scheduled to be transmitted to the first Rx device 510-a.

In this example illustrated in the first resource configuration 500-a, the second Tx device 505-b may shorten a length of the non-data signal 520-a to be the same length of the second data signal 515-b in order to avoid a change in power amplifier phase at the second Tx device 505-b when transmitting the non-data signal 520-a and the second data signal 515-b. In this example, the first Rx device 510-a that is provided physical layer security may receive the first data signal 515-a of size Y and the shortened non-data signal 520-a of size X, where Y>X (e.g., the first data signal 515-a is longer than the shortened non-data signal 520-a). In such cases, the first data signal 515-a may experience different phases (e.g., no phase continuity or coherency) and different interference levels, which could hurt the reliability with which the first data signal 515-a is able to be received and decoded. In particular, the noise/interference level at the first Rx device 510-a may be different across the first data signal 515-a, and channel estimation performed for the first data signal 515-a may not be used before and after the last symbols of the shortened non-data signal 520-a.

In this regard, the fact that the non-data signal 520-a is being used by multiple Rx devices 510 may result in complications with the ability of the second Tx device 505-b to unilaterally modify a length of the non-data signal 520-a.

Accordingly, in some implementations, the second Tx device 505-b may be configured to modify (e.g., shorten, extend) the length of the non-data signal 520 only if the data signal 515 to be protected is the same size as, or smaller than, the length of the non-data signal 520 after manipulation.

In this regard, because first data signal 515-a (which is provided physical layer protection by the non-data signal 520-a) would be longer than the non-data signal 520-a after shortening the non-data signal 520-a, the second Tx device 505-b may not be expected to shorten the non-data signal 520-a as shown in the first resource configuration 500-a. In other words, the second Tx device 505-b may refrain from shortening the non-data signal 520-a to match the second data signal 515-b as shown in the first resource configuration 500-a because shortening the non-data signal 520-a would result in the shortened non-data signal 520-a being shorter than the first data signal 515-a that is protected by the non-data signal 520-a.

Comparatively, reference will now be made to the second resource configuration 500-b. As shown in the second resource configuration 500-b, the first Tx device 505-a may be scheduled to transmit a first data signal 515-c to the first Rx device 510-a. Similarly, the second Tx device 505-b may be scheduled to transmit a second data signal 515-d to the second Rx device 510-b. Moreover, the second Tx device 505-b may be scheduled to transmit a non-data signal 520-b to the first Rx device 510-a and the second Rx device 510-b. The first data signal 515-c, the second data signal 515-d, and the non-data signal 520-b may all at least partially overlap with one another in the time domain. Further, as shown in FIG. 5, the second data signal 515-d, may be longer than the first data signal 515-c and the non-data signal 520-b in the time domain.

In some aspects, the non-data signal 520-b may serve as an energy signal for an energy-harvesting procedure at the second Rx device 510-b, and may provide physical layer protection for the first data signal 515-c scheduled to be transmitted to the first Rx device 510-a.

In this example illustrated in the second resource configuration 500-b, the second Tx device 505-b may extend a length of the non-data signal 520-b to be the same length of the second data signal 515-d in order to avoid a change in power amplifier phase at the second Tx device 505-b when transmitting the non-data signal 520-b and the second data signal 515-d. As shown in the second resource configuration 500-b, the first data signal 515-c is shorter than the modified non-data signal 520-b. As such, the modification of the non-data signal 520-b may be expected or allowed, as the modified length of the non-data signal 520-b may not result in any phase continuity issues with the first data signal 515-c.

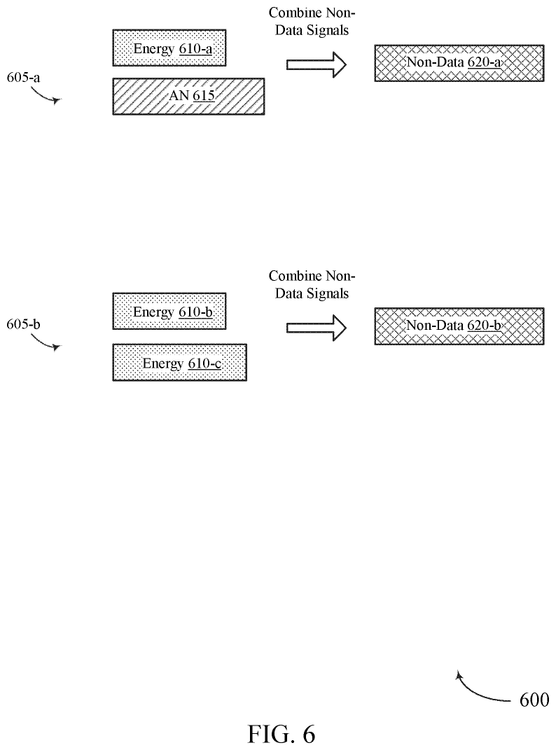

FIG. 6 illustrates an example of a resource configuration 600 that supports techniques for multiplexing data and non-data signals in accordance with one or more aspects of the present disclosure. In some examples, aspects of the resource configuration 600 may implement, or be implemented by, aspects of the wireless communications system 100, the wireless communications system 200, the resource configurations 300-500, or any combination thereof.

In some implementations, if a Tx device (e.g., network entity 105, UE 115) is scheduled to transmit multiple non-data signals, the Tx device may be configured to combine the respective non-data signals. In particular, a Tx device may be configured to combine multiple non-data signals that are scheduled to be transmitted to the same Rx device. In this regard, Tx devices described herein may be configured to combine multiple energy signals, artificial noise signals, or any combination thereof.

In some aspects, when combining multiple non-data signals, the Tx device may be configured to utilize a multiplexing/dropping procedure with some change in configuration. Stated differently, Tx wireless devices may be configured to utilize some multiplexing/dropping configuration that causes the Tx wireless device to combine the non-data signals in a specified or expected manner. In such cases, multiplexing/dropping configuration may cause the Tx wireless device to generate a combined non-data signal such that the parameters of the combined non-data signal (e.g., allocation size, transmit power, target power, repetition factor for repeated non-data signals) may be based on the parameters of the respective original non-data signals. In additional or alternative implementations, a multiplexing/dropping configuration may cause the Tx wireless device to drop one or more of the non-data signals when the respective non-data signals are scheduled to be transmitted to the same Rx device in temporally overlapping time resources.

For example, referring to a first configuration 605-a illustrated in FIG. 6, a Tx wireless device (e.g., UE 115, network entity 105) may be scheduled to transmit an energy signal 610-a (e.g., first non-data signal) and an artificial noise signal 615 (e.g., second non-data signal). In some cases, the energy signal 610-a and the artificial noise signal 615 may be scheduled to be transmitted to the same Rx wireless device, or to different Rx wireless devices. Moreover, the scheduled resources of the energy signal 610-a and the artificial noise signal 615 may at least partially overlap in the time domain. In some aspects, the energy signal 610-a may be associated with a first set of parameters (e.g., first allocation size, first transmit power, first target power, first repetition factor), and the artificial noise signal 615 may be associated with a second set of parameters (e.g., second allocation size, second transmit power, second target power, second repetition factor).

In this example, the Tx wireless device may combine (e.g., multiplex) the energy signal 610-a and the artificial noise signal 615 to generate a combined or composite non-data signal 620-a that is transmitted to the scheduled Rx device(s). The composite non-data signal 620-a may be associated with a third set of parameters (e.g., third allocation size, third transmit power, third target power, third repetition factor) that is based on the first and second sets of parameters associated with the energy signal 610-a and the artificial noise signal 615, respectively.

Similarly, referring to a second configuration 605-b illustrated in FIG. 6, the Tx wireless device (e.g., UE 115, network entity 105) may be scheduled to transmit a first energy signal 610-b (e.g., first non-data signal) and a second energy signal 610-c (e.g., second non-data signal). The energy signals 610-b, 610-c may be scheduled to be transmitted to the same Rx wireless device, or to different Rx wireless devices. Moreover, the scheduled resources of the energy signals 610-b, 610-c may at least partially overlap in the time domain. In this example, the Tx wireless device may combine (e.g., multiplex) the energy signals 610-b, 610-c to generate a combined or composite non-data signal 620-b that is transmitted to the scheduled Rx device(s). The composite non-data signal 620-a may be associated with a set of parameters (e.g., allocation size, transmit power, target power, repetition factor) that is based on respective sets of parameters associated with the respective energy signals 610-b, 610-c.

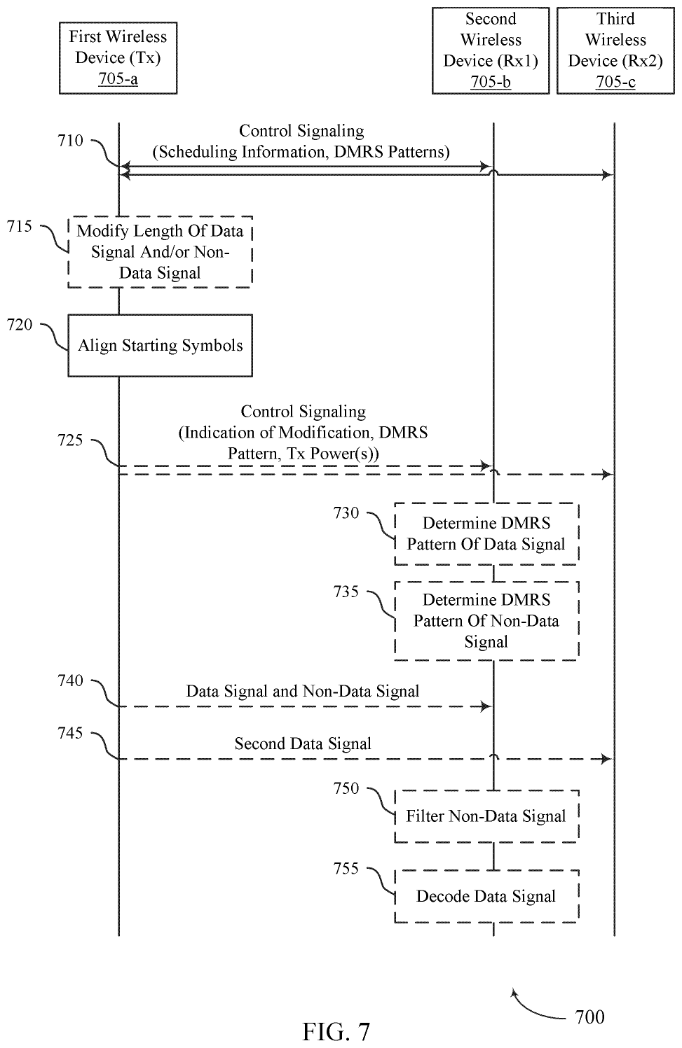

FIG. 7 illustrates an example of a process flow 700 that supports techniques for multiplexing data and non-data signals in accordance with one or more aspects of the present disclosure. In some examples, aspects of the process flow 700 may implement, or be implemented by, aspects of the wireless communications system 100, the wireless communications system 200, the resource configurations 300-600, or any combination thereof. In particular, the process flow 700 illustrates signaling between wireless devices 705 that enables non-data signals to be aligned and transmitted simultaneously with data signals, as described with reference to FIGS. 1-6, among other aspects.

The process flow 700 may include a first wireless device 705-a (e.g., Tx device), a second wireless device 705-b (e.g., first Rx device), and a third wireless device 705-c (e.g., second Rx device), which may be examples of passive devices, UEs 115, network entities 105, and other wireless devices described with reference to FIGS. 1-6. For example, the first wireless device 705-a and the second wireless device 705-b illustrated in FIG. 7 may be examples of the network entity 105-a and the first UE 115-a, as shown and described in FIG. 2. By way of another example, the first wireless device 705-a, the second wireless device 705-b, and the third wireless device 705-c illustrated in FIG. 7 may be examples of the Tx device 305-b, the Rx device 310-a, and the Rx device 310-b, as shown and described in FIG. 3.

In some examples, the operations illustrated in process flow 700 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 710, the first wireless device 705-a, the second wireless device 705-b, the third wireless device 705-c, or any combination thereof, may receive control signaling indicating scheduling information for a data signal and non-data signals to be communicated between the respective wireless devices 705. The respective wireless devices 705 may receive the control signaling indicating the scheduling information at 705 from one another, from another wireless device (e.g., network entity 105), or both.

For example, the first wireless device 705-a may receive scheduling information that schedules the first wireless device 705-a to transmit, to the second wireless device 705-b, temporally overlapping transmissions of a data signal and a non-data signal, such as an energy signal or an artificial noise signal. In some cases, the scheduling information may additionally schedule the first wireless device 705-a to transmit an additional data signal to the third wireless device 705-c. Similarly, the second wireless device 705-b may receive scheduling information that schedules the second wireless device 705-b to receive, from the first wireless device 705-a, temporally overlapping transmissions of the data signal and the non-data signal.

As described previously herein, the data signal may include data that is intended to be decoded by the intended Rx device. Comparatively, the non-data signal may not include any data that is intended to be decoded by the respective Rx devices. The non-data signal may include an energy signal associated with an energy-harvesting device (e.g., passive device such as an RFID tag), an artificial noise signal intended to provide physical layer security or protection for the scheduled data signal or another data signal, or both.

In some implementations, the scheduling information may indicate a DMRS pattern associated with the data signal, the non-data signal, or both. Additionally, or alternatively, the scheduling information may indicate a secret key that may be utilized to transmit and filter out the non-data signal from the temporally overlapping data signal.

At 715, the first wireless device 705-a may modify a length of the data signal, the non-data signal, or both. In particular, the first wireless device 705-a may modify a length of the data signal and/or the non-data signal based on the data signal and the non-data signal at least partially overlapping in the time domain. In this regard, the first wireless device 705-a may modify the length of the data signal and/or the non-data signal based on receiving the scheduling information at 710.

As described previously herein with respect to FIGS. 2-6, the first wireless device 705-a may modify the length of the respective signals so that the respective signals are the same length, so that one of the signals is longer than the other, etc.

For example, in some cases, the scheduling information may schedule the data signal that is longer than the non-data signal. In this example, the first wireless device 705-a may shorten or restrict the length of the data signal so that the length of the data signal is the same as, or shorter than, the length of the non-data signal.

By way of another example, the scheduling information may schedule the non-data signal that is longer than the data signal. In such cases, the behavior of the first wireless device 705-a may depend on the type of the non-data signal (e.g., whether the non-data signal includes an energy signal or an artificial noise signal), the length of the data signal, the length of another data signal that the non-data signal is intended to protect, or any combination thereof.

For instance, in cases where the non-data signal includes an artificial noise signal that is longer than the data signal, the first wireless device 705-a may shorten or restrict the length of the artificial noise signal so that the length of the artificial noise signal is the same as the length of the data signal to be transmitted to the second wireless device 705-b, the length of the second data signal to be transmitted to the third wireless device 705-c, or both.

By way of another example, in cases where the non-data signal includes an energy signal that is shorter than the data signal, the first wireless device 705-a may extend the length of the energy signal so that the length of the energy signal is the same as, or longer than, the length of the data signal to be transmitted to the second wireless device 705-b, the length of the second data signal to be transmitted to the third wireless device 705-c, or both.

In some cases, the first wireless device 705-a may not be configured to modify a length of either the data signal or the non-data signal. For example, in cases where the non-data signal (e.g., energy signal, artificial noise signal) is longer than the data signal, this may not result in any phase coherency issues with respect to the data signal. Accordingly, in such cases, the first wireless device 705-a may leave the non-data signal as-is (e.g., refrain from shortening the non-data signal).

At 720, the first wireless device 705-a may align the data signal and the non-data signal. In particular, the first wireless device 705-a may align a starting symbol of the data signal and a starting symbol of the non-data signal. The first wireless device 705-a may align the data signal and the non-data signal based on the respective signals being scheduled to at least temporally overlap. Moreover, the first wireless device 705-a may perform the alignment at 720 based on modifying the length of the data signal and/or the non-data signal at 715 (e.g., align the modified lengths of the data signal and/or the non-data signal).

For example, in cases where the first wireless device 705-a is scheduled to transmit the data signal and the non-data signal to the second wireless device 705-b, the first wireless device 705-a may align starting symbols of the respective data and non-data signal. By way of another example, in cases where the first wireless device 705-a is scheduled to transmit a first data signal and the non-data signal to the second wireless device 705-b, and a second data signal to the third wireless device 705-c, the first wireless device 705-a may align starting symbols of the first data signal, the second data signal, and the non-data signal.

At 725, the first wireless device 705-a may transmit control signaling to the second wireless device 705-b, the third wireless device 705-c, or both, where the control signaling includes an indication of any modifications made at 715. In this regard, in cases where the first wireless device 705-a modifies a length of the data signal and/or the non-data signal at 715, the first wireless device 705-a may indicate how the data signal and/or the non-data signal have been modified relative to the original scheduling information.

In some aspects, the control signaling at 725 may indicate additional or alternative parameters associated with the scheduled data signal and/or non-data signal. Other parameters or characteristics that may be indicated may include, but are not limited to, DMRS patterns of the (modified) data signal and/or non-data signal, transmit powers of the data signal and/or non-data signal, and the like.

At 730, the second wireless device 705-b may determine a DMRS pattern of the data signal that is scheduled to be transmitted by the first wireless device 705-a to the second wireless device 705-b. In some implementations, the second wireless device 705-b may determine the DMRS pattern of the data signal based on the original scheduling information, based on other signaling from the first wireless device 705-a or another wireless device, or any combination thereof. In this regard, the second wireless device 705-b may determine the DMRS pattern of the data signal based on the control signaling at 710, the control signaling at 725, or both.

At 735, the second wireless device 705-b may determine a DMRS pattern of the non-data signal that is scheduled to be transmitted by the first wireless device 705-a to the second wireless device 705-b. In some aspects, the DMRS pattern of the non-data signal may be based on the DMRS pattern of the data signal. In this regard, the second wireless device 705-b may determine the DMRS pattern of the non-data signal based on the DMRS pattern of the data signal that was determined at 730. As such, the second wireless device 705-b may determine the DMRS pattern of the non-data signal based on receiving the control signaling at 710, receiving the control signaling at 725, determining the DMRS pattern of the data signal at 730, or any combination thereof.

In some aspects, the second wireless device 705-b may determine the DMRS pattern of the non-data signal in accordance with a DMRS mapping configuration for DMRS patterns. In particular, the second wireless device 705-b may map the DMRS pattern of the data signal (determined at 730) to the DMRS pattern of the non-data signal (determined at 735) in accordance with a DMRS mapping configuration. In such cases, the DMRS mapping configuration may be configured at the second wireless device 705-b, signaled to the second wireless device 705-b by the first wireless device 705-a (e.g., via control signaling at 710 and/or 725), signaled to the second wireless device 705-b by another wireless device, or any combination thereof.

At 740, the first wireless device 705-a may transmit the data signal and the non-data signal to the second wireless device 705-b. As described previously herein, the data signal and the non-data signal may at least partially overlap in the time domain. In particular, the first wireless device 705-a may transmit the data signal and the non-data signal to the second wireless device 705-b based on the scheduling information and aligning the respective signals at 720. In this regard, the first wireless device 705-a may transmit the data signal and the non-data signal based on receiving the scheduling information at 710, modifying the length of the data signal and/or the non-data signal at 715, aligning the data signal and the non-data signal at 720, transmitting the control signaling at 725, or any combination thereof.

The first wireless device 705-a may be configured to transmit the data signal and/or the non-data signal in accordance with the scheduling information and the indicated parameters of the respective signals, including the respective DMRS patterns, the respective transmit powers, and the like. For example, as described previously herein with respect to FIG. 4, in cases where the non-data signal (e.g., energy signal) is longer than the data signal, the first wireless device 705-a may transmit the data signal using a first transmit power, and may transmit different portions of the non-data signal using multiple different transmit powers. For instance, a first portion of the non-data signal that overlaps with the data signal may be transmitted according to a first transmit power, and a second portion of the non-data signal that does not overlap with the data signal may be transmitted according to a third transmit power that is greater than the second transmit power. In such cases, the third transmit power may be based on the first transmit power of the data signal, the second transmit power of the first portion of the non-data signal, or both.

At 745, the first wireless device 705-a may transmit the additional data signal to the third wireless device 705-c. As described previously herein, the additional data signal at 745 may at least partially overlap in the time domain with the data signal and the non-data signal at 740. For example, as shown in FIG. 6, the second data signal 515-b may at least partially overlap in the time domain with the data signal 515-a and the non-data signal 520-a. The first wireless device 705-a may transmit the additional data signal at 745 based on receiving the scheduling information at 710, modifying the length of the data signal and/or the non-data signal at 715, aligning the data signal and the non-data signal at 720, transmitting the control signaling at 725, or any combination thereof.

At 750, the second wireless device 705-b may filter the non-data signal from the data signal received at 740. In other words, the second wireless device 705-b may be configured to receive signal energy including the data signal and the non-data signal at 740, identify a portion of the signal energy that is attributable to the non-data signal, and filter or cancel out the portion of the signal energy that is attributable to the non-data signal. In some aspects, the second wireless device 705-b may filter out the non-data signal from the data signal based on the DMRS pattern of the non-data signal, the DMRS pattern of the data signal, or both. In this regard, the second wireless device 705-b may filter out the non-data signal based on receiving the scheduling information at 705, receiving the control signaling at 725, determining the DMRS pattern of the data signal at 730, determining the DMRS pattern of the non-data signal at 735, receiving the data signal and the non-data signal at 740, or any combination thereof.

At 755, the second wireless device 705-b may decode the data signal. In particular, the second wireless device 705-b may decode the data signal based on filtering out (e.g., canceling out) the non-data signal from the data signal at 750.

Techniques described herein may enable wireless devices to efficiently and effectively transmit data signals and temporally overlapping non-data signals, such as energy signals and artificial noise signals. In particular, aspects of the present disclosure may enable non-data signals to be transmitted simultaneously with data signals in order to facilitate energy harvesting processes for energy harvesting devices, provide physical layer protection for the data signals, or both. Moreover, the rules and configurations of the present disclosure may enable non-data signals to be simultaneously transmitted along with data signals in such a manner as to reduce or eliminate detrimental effects of the non-data signals at Rx devices. As such, aspects of the present disclosure may improve an efficiency and reliability of wireless communications within the wireless communications system.

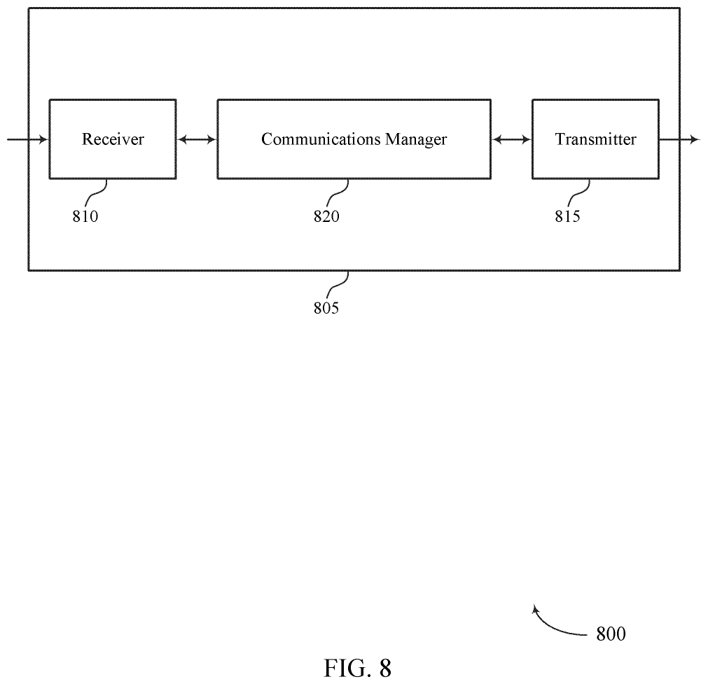

FIG. 8 shows a block diagram 800 of a device 805 that supports techniques for multiplexing data and non-data signals in accordance with one or more aspects of the present disclosure. The device 805 may be an example of aspects of a wireless device such as a UE 115, a network entity 105, or other wireless device, as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for multiplexing data and non-data signals). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for multiplexing data and non-data signals). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of techniques for multiplexing data and non-data signals as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

For example, the communications manager 820 may be configured as or otherwise support a means for receiving scheduling information that schedules temporally overlapping transmissions by the wireless device of a data signal and an additional signal, where the additional signal includes an artificial noise signal, an energy signal associated with an energy-harvesting device, or both. The communications manager 820 may be configured as or otherwise support a means for aligning a starting symbol of the additional signal with a starting symbol of the data signal based on the data signal and the additional signal being scheduled to temporally overlap. The communications manager 820 may be configured as or otherwise support a means for transmitting the data signal and the additional signal based on the aligning.

For example, the communications manager 820 may be configured as or otherwise support a means for receiving a data signal and an additional signal, where at least a portion of the data signal temporally overlaps with at least a portion of the additional signal, and where the additional signal includes an artificial noise signal, an energy signal associated with an energy harvesting device, or both. The communications manager 820 may be configured as or otherwise support a means for determining a first DMRS pattern associated with the additional signal based on a second DMRS pattern associated with the data signal. The communications manager 820 may be configured as or otherwise support a means for filtering the additional signal from the data signal based on the first DMRS pattern associated with the additional signal. The communications manager 820 may be configured as or otherwise support a means for decoding the data signal based on the filtering.

By including or configuring the communications manager 820 in accordance with examples as described herein, the device 805 (e.g., a processor controlling or otherwise coupled with the receiver 810, the transmitter 815, the communications manager 820, or a combination thereof) may support techniques that enable wireless devices to efficiently and effectively transmit data signals and temporally overlapping non-data signals, such as energy signals and artificial noise signals. In particular, aspects of the present disclosure may enable non-data signals to be transmitted simultaneously with data signals in order to facilitate energy harvesting processes for energy harvesting devices, provide physical layer protection for the data signals, or both. Moreover, the rules and configurations of the present disclosure may enable non-data signals to be simultaneously transmitted along with data signals in such a manner as to reduce or eliminate detrimental effects of the non-data signals at Rx devices. As such, aspects of the present disclosure may improve an efficiency and reliability of wireless communications within the wireless communications system.

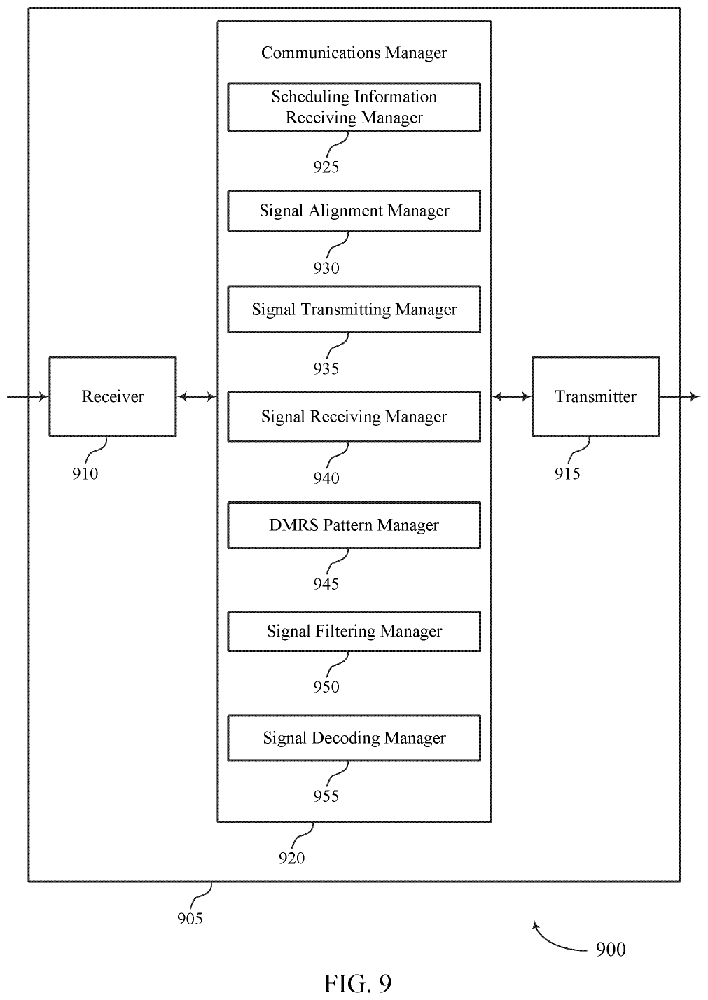

FIG. 9 shows a block diagram 900 of a device 905 that supports techniques for multiplexing data and non-data signals in accordance with one or more aspects of the present disclosure. The device 905 may be an example of aspects of a device 805, such as a UE 115, a network entity 105, or other wireless device, as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for multiplexing data and non-data signals). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for multiplexing data and non-data signals). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for multiplexing data and non-data signals as described herein. For example, the communications manager 920 may include a scheduling information receiving manager 925, a signal alignment manager 930, a signal transmitting manager 935, a signal receiving manager 940, a DMRS pattern manager 945, a signal filtering manager 950, a signal decoding manager 955, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The scheduling information receiving manager 925 may be configured as or otherwise support a means for receiving scheduling information that schedules temporally overlapping transmissions by the wireless device of a data signal and an additional signal, where the additional signal includes an artificial noise signal, an energy signal associated with an energy-harvesting device, or both. The signal alignment manager 930 may be configured as or otherwise support a means for aligning a starting symbol of the additional signal with a starting symbol of the data signal based on the data signal and the additional signal being scheduled to temporally overlap. The signal transmitting manager 935 may be configured as or otherwise support a means for transmitting the data signal and the additional signal based on the aligning.

The signal receiving manager 940 may be configured as or otherwise support a means for receiving a data signal and an additional signal, where at least a portion of the data signal temporally overlaps with at least a portion of the additional signal, and where the additional signal includes an artificial noise signal, an energy signal associated with an energy harvesting device, or both. The DMRS pattern manager 945 may be configured as or otherwise support a means for determining a first DMRS pattern associated with the additional signal based on a second DMRS pattern associated with the data signal. The signal filtering manager 950 may be configured as or otherwise support a means for filtering the additional signal from the data signal based on the first DMRS pattern associated with the additional signal. The signal decoding manager 955 may be configured as or otherwise support a means for decoding the data signal based on the filtering.

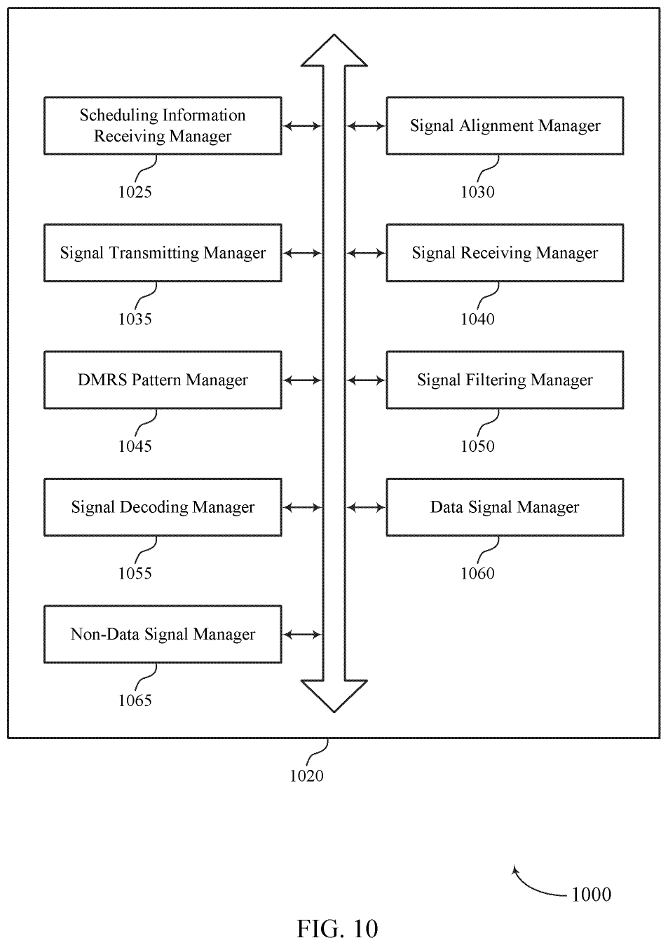

FIG. 10 shows a block diagram 1000 of a communications manager 1020 that supports techniques for multiplexing data and non-data signals in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for multiplexing data and non-data signals as described herein. For example, the communications manager 1020 may include a scheduling information receiving manager 1025, a signal alignment manager 1030, a signal transmitting manager 1035, a signal receiving manager 1040, a DMRS pattern manager 1045, a signal filtering manager 1050, a signal decoding manager 1055, a data signal manager 1060, a non-data signal manager 1065, or any combination thereof. Each of these components may communicate, directly or indirectly, with one another (e.g., via one or more buses).

The scheduling information receiving manager 1025 may be configured as or otherwise support a means for receiving scheduling information that schedules temporally overlapping transmissions by the wireless device of a data signal and an additional signal, where the additional signal includes an artificial noise signal, an energy signal associated with an energy-harvesting device, or both. The signal alignment manager 1030 may be configured as or otherwise support a means for aligning a starting symbol of the additional signal with a starting symbol of the data signal based on the data signal and the additional signal being scheduled to temporally overlap. The signal transmitting manager 1035 may be configured as or otherwise support a means for transmitting the data signal and the additional signal based on the aligning.

In some examples, the data signal manager 1060 may be configured as or otherwise support a means for modifying a length of the data signal such that the data signal includes a first quantity of symbols that is less than or equal to a second quantity of signals associated with the additional signal, where aligning the starting symbol of the additional signal with the starting symbol of the data signal is based on the modifying.

In some examples, the non-data signal manager 1065 may be configured as or otherwise support a means for modifying a length of the additional signal such that the additional signal and the data signal include equal quantities of symbols, where aligning the starting symbol of the additional signal with the starting symbol of the data signal is based on the modifying.

In some examples, the signal transmitting manager 1035 may be configured as or otherwise support a means for transmitting an indication of the modifying to the second wireless device, where transmitting the additional signal is based on transmitting the indication of the modifying. In some examples, the data signal includes a first quantity of symbols and the additional signal includes a second quantity of symbols that is greater than the first quantity of symbols.

In some examples, the signal transmitting manager 1035 may be configured as or otherwise support a means for transmitting the first portion of the additional signal in accordance with a first transmit power. In some examples, the signal transmitting manager 1035 may be configured as or otherwise support a means for transmitting the second portion of the additional signal in accordance with a second transmit power that is greater than the first transmit power based on the second portion of the additional signal not temporally overlapping with the data signal. In some examples, the data signal is transmitted in accordance with a third transmit power. In some examples, the second transmit power is based on a sum of the first transmit power and the third transmit power.

In some examples, the signal transmitting manager 1035 may be configured as or otherwise support a means for communicating a message indicating a difference between the second transmit power and the sum of the first transmit power and the third transmit power.

In some examples, the additional signal is transmitted to a second wireless device. In some examples, transmitting the second portion of the additional signal in accordance with the second transmit power that is greater than the first transmit power is based on a first power level of the wireless device being greater than or equal to a first threshold power level, a first charging rate of the wireless device being greater than or equal to a first threshold charging rate, a second power level of the second wireless device less than or equal to a second threshold power level, a second charging rate of the second wireless device being less than or equal to a second threshold charging rate, or any combination thereof.

In some examples, the non-data signal manager 1065 may be configured as or otherwise support a means for modifying a length of the additional signal such that the additional signal and the data signal include equal quantities of symbols, where aligning the starting symbol of the additional signal with the starting symbol of the data signal is based on the modifying.

In some examples, the signal transmitting manager 1035 may be configured as or otherwise support a means for transmitting an indication of the modifying to the second wireless device, the third wireless device, or both, where transmitting the data signal, transmitting the additional signal, or both, is based on transmitting the indication of the modifying. In some examples, data signal is associated with a first DMRS pattern and the additional signal is associated with a second DMRS pattern that is based on the first DMRS pattern.

In some examples, the non-data signal manager 1065 may be configured as or otherwise support a means for modifying a length of the additional signal such that the additional signal includes a same quantity of symbols as the data signal, the second data signal, or both, where aligning the starting symbol of the additional signal with the starting symbol of the data signal is based on the modifying.

In some examples, the signal transmitting manager 1035 may be configured as or otherwise support a means for transmitting the data signal and the modified additional signal to a second wireless device. In some examples, the signal transmitting manager 1035 may be configured as or otherwise support a means for transmitting the second data signal and the modified additional signal to a third wireless device different from the second wireless device.

In some examples, the signal transmitting manager 1035 may be configured as or otherwise support a means for transmitting a third additional signal to the second wireless device based on the scheduling information, where the third additional signal is based on the additional signal and the second additional signal.

In some examples, the additional signal and the second additional signal are associated with a first set of parameters and a second set of parameters, respectively. In some examples, the third additional signal is associated with a third set of parameters that is based on the first set of parameters and the second set of parameters. In some examples, the first set of parameters, the second set of parameters, the third set of parameters, or any combination thereof, include an allocation size, a transmit power, a target power, a repetition factor, or any combination thereof. In some examples, the additional signal includes the artificial noise signal that is configured to provide physical layer security for the data signal, an additional data signal, or both, against unintended receiver devices.

In some examples, the signal transmitting manager 1035 may be configured as or otherwise support a means for transmitting the data signal with a same phase coherency based on aligning the starting symbol of the additional signal with the starting symbol of the data signal.

The signal receiving manager 1040 may be configured as or otherwise support a means for receiving a data signal and an additional signal, where at least a portion of the data signal temporally overlaps with at least a portion of the additional signal, and where the additional signal includes an artificial noise signal, an energy signal associated with an energy harvesting device, or both. The DMRS pattern manager 1045 may be configured as or otherwise support a means for determining a first DMRS pattern associated with the additional signal based on a second DMRS pattern associated with the data signal. The signal filtering manager 1050 may be configured as or otherwise support a means for filtering the additional signal from the data signal based on the first DMRS pattern associated with the additional signal. The signal decoding manager 1055 may be configured as or otherwise support a means for decoding the data signal based on the filtering.

In some examples, the signal receiving manager 1040 may be configured as or otherwise support a means for receiving control signaling indicating a mapping configuration for DMRS patterns, where the first DMRS pattern is determined based on the mapping configuration. In some examples, the DMRS pattern manager 1045 may be configured as or otherwise support a means for receiving an indication of the second DMRS pattern, where receiving the data signal and determining the first DMRS pattern is based on receiving the indication of the second DMRS pattern.

In some examples, the scheduling information receiving manager 1025 may be configured as or otherwise support a means for receiving scheduling information that schedules the wireless device to receive the data signal and the additional signal from a second wireless device. In some examples, the signal receiving manager 1040 may be configured as or otherwise support a means for receiving, from the second wireless device and based on the scheduling information, an indication of a modification of the data signal, the additional signal, or both, where receiving the data signal and the additional signal is based on receiving the indication of the modification. In some examples, the data signal includes a first quantity of symbols and the additional signal includes a second quantity of symbols that is greater than the first quantity of symbols.

In some examples, the additional signal includes a first portion that temporally overlaps with the data signal and a second portion that does not temporally overlap with the data signal, and the signal receiving manager 1040 may be configured as or otherwise support a means for receiving the first portion of the additional signal in accordance with a first transmit power. In some examples, the additional signal includes a first portion that temporally overlaps with the data signal and a second portion that does not temporally overlap with the data signal, and the signal receiving manager 1040 may be configured as or otherwise support a means for receiving the second portion of the additional signal in accordance with a second transmit power that is greater than the first transmit power based on the second portion of the additional signal not temporally overlapping with the data signal.

In some examples, the data signal is received in accordance with a third transmit power. In some examples, the second transmit power is based on a sum of the first transmit power and the third transmit power. In some examples, the signal receiving manager 1040 may be configured as or otherwise support a means for receiving a message indicating a difference between the second transmit power and the sum of the first transmit power and the third transmit power.

In some examples, the additional signal includes the artificial noise signal that is configured to provide physical layer security for the data signal, an additional data signal, or both, against unintended receiver devices. In some examples, the signal decoding manager 1055 may be configured as or otherwise support a means for decoding the data signal based on the data signal including a same phase coherency across the data signal.

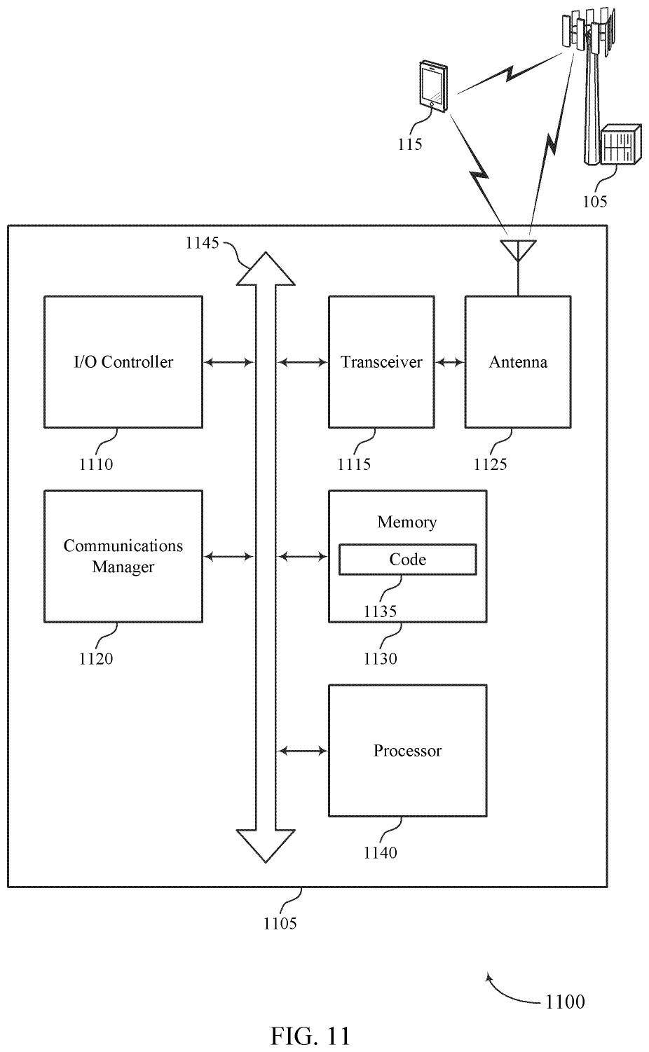

FIG. 11 shows a diagram of a system 1100 including a device 1105 that supports techniques for multiplexing data and non-data signals in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting techniques for multiplexing data and non-data signals). For example, the device 1105 or a component of the device 1105 may include a processor 1140 and memory 1130 coupled with or to the processor 1140, the processor 1140 and memory 1130 configured to perform various functions described herein.

For example, the communications manager 1120 may be configured as or otherwise support a means for receiving scheduling information that schedules temporally overlapping transmissions by the wireless device of a data signal and an additional signal, where the additional signal includes an artificial noise signal, an energy signal associated with an energy-harvesting device, or both. The communications manager 1120 may be configured as or otherwise support a means for aligning a starting symbol of the additional signal with a starting symbol of the data signal based on the data signal and the additional signal being scheduled to temporally overlap. The communications manager 1120 may be configured as or otherwise support a means for transmitting the data signal and the additional signal based on the aligning.

For example, the communications manager 1120 may be configured as or otherwise support a means for receiving a data signal and an additional signal, where at least a portion of the data signal temporally overlaps with at least a portion of the additional signal, and where the additional signal includes an artificial noise signal, an energy signal associated with an energy harvesting device, or both. The communications manager 1120 may be configured as or otherwise support a means for determining a first DMRS pattern associated with the additional signal based on a second DMRS pattern associated with the data signal. The communications manager 1120 may be configured as or otherwise support a means for filtering the additional signal from the data signal based on the first DMRS pattern associated with the additional signal. The communications manager 1120 may be configured as or otherwise support a means for decoding the data signal based on the filtering.

By including or configuring the communications manager 1120 in accordance with examples as described herein, the device 1105 may support techniques that enable wireless devices to efficiently and effectively transmit data signals and temporally overlapping non-data signals, such as energy signals and artificial noise signals. In particular, aspects of the present disclosure may enable non-data signals to be transmitted simultaneously with data signals in order to facilitate energy harvesting processes for energy harvesting devices, provide physical layer protection for the data signals, or both. Moreover, the rules and configurations of the present disclosure may enable non-data signals to be simultaneously transmitted along with data signals in such a manner as to reduce or eliminate detrimental effects of the non-data signals at Rx devices. As such, aspects of the present disclosure may improve an efficiency and reliability of wireless communications within the wireless communications system.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of techniques for multiplexing data and non-data signals as described herein, or the processor 1140 and the memory 1130 may be otherwise configured to perform or support such operations.

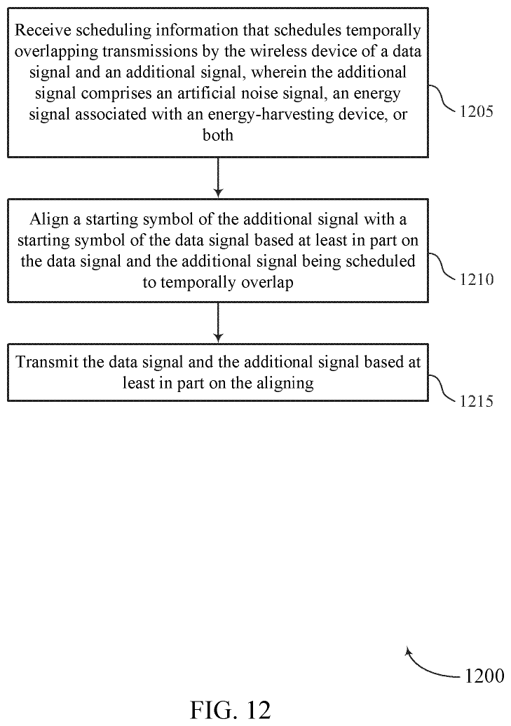

FIG. 12 shows a flowchart illustrating a method 1200 that supports techniques for multiplexing data and non-data signals in accordance with one or more aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include receiving scheduling information that schedules temporally overlapping transmissions by the wireless device of a data signal and an additional signal, where the additional signal includes an artificial noise signal, an energy signal associated with an energy-harvesting device, or both. The operations of 1205 may be performed in accordance with examples as disclosed herein. In some examples, aspects of the operations of 1205 may be performed by a scheduling information receiving manager 1025 as described with reference to FIG. 10.

At 1210, the method may include aligning a starting symbol of the additional signal with a starting symbol of the data signal based at least in part on the data signal and the additional signal being scheduled to temporally overlap. The operations of 1210 may be performed in accordance with examples as disclosed herein. In some examples, aspects of the operations of 1210 may be performed by a signal alignment manager 1030 as described with reference to FIG. 10.

At 1215, the method may include transmitting the data signal and the additional signal based at least in part on the aligning. The operations of 1215 may be performed in accordance with examples as disclosed herein. In some examples, aspects of the operations of 1215 may be performed by a signal transmitting manager 1035 as described with reference to FIG. 10.

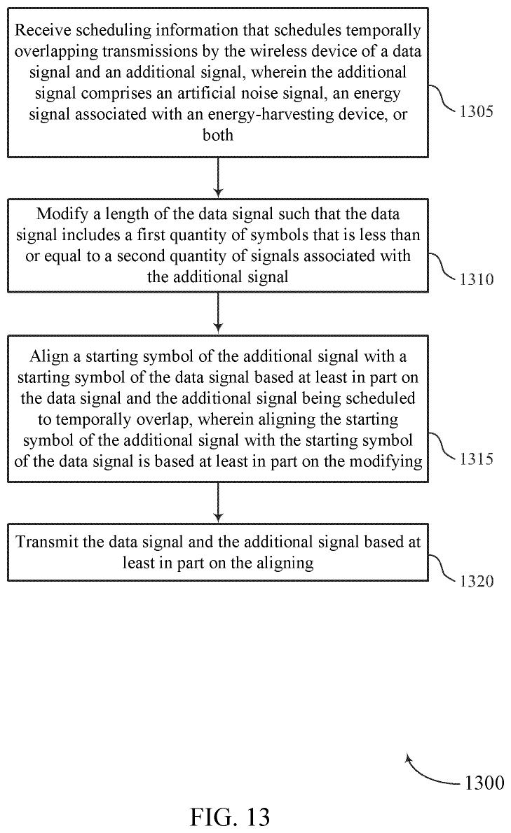

FIG. 13 shows a flowchart illustrating a method 1300 that supports techniques for multiplexing data and non-data signals in accordance with one or more aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1305, the method may include receiving scheduling information that schedules temporally overlapping transmissions by the wireless device of a data signal and an additional signal, where the additional signal includes an artificial noise signal, an energy signal associated with an energy-harvesting device, or both. The operations of 1305 may be performed in accordance with examples as disclosed herein. In some examples, aspects of the operations of 1305 may be performed by a scheduling information receiving manager 1025 as described with reference to FIG. 10.

At 1310, the method may include modifying a length of the data signal such that the data signal includes a first quantity of symbols that is less than or equal to a second quantity of signals associated with the additional signal. The operations of 1310 may be performed in accordance with examples as disclosed herein. In some examples, aspects of the operations of 1310 may be performed by a data signal manager 1060 as described with reference to FIG. 10.

At 1315, the method may include aligning a starting symbol of the additional signal with a starting symbol of the data signal based at least in part on the data signal and the additional signal being scheduled to temporally overlap, where aligning the starting symbol of the additional signal with the starting symbol of the data signal is based on the modifying. The operations of 1315 may be performed in accordance with examples as disclosed herein. In some examples, aspects of the operations of 1315 may be performed by a signal alignment manager 1030 as described with reference to FIG. 10.

At 1320, the method may include transmitting the data signal and the additional signal based at least in part on the aligning. The operations of 1320 may be performed in accordance with examples as disclosed herein. In some examples, aspects of the operations of 1320 may be performed by a signal transmitting manager 1035 as described with reference to FIG. 10.

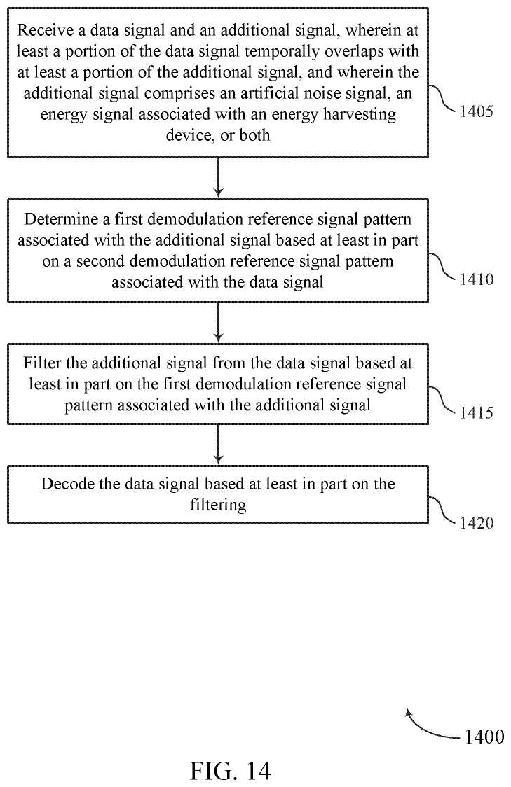

FIG. 14 shows a flowchart illustrating a method 1400 that supports techniques for multiplexing data and non-data signals in accordance with one or more aspects of the present disclosure. The operations of the method 1400 may be implemented by a UE or its components as described herein. For example, the operations of the method 1400 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1405, the method may include receiving a data signal and an additional signal, where at least a portion of the data signal temporally overlaps with at least a portion of the additional signal, and where the additional signal includes an artificial noise signal, an energy signal associated with an energy harvesting device, or both. The operations of 1405 may be performed in accordance with examples as disclosed herein. In some examples, aspects of the operations of 1405 may be performed by a signal receiving manager 1040 as described with reference to FIG. 10.

At 1410, the method may include determining a first DMRS pattern associated with the additional signal based at least in part on a second DMRS pattern associated with the data signal. The operations of 1410 may be performed in accordance with examples as disclosed herein. In some examples, aspects of the operations of 1410 may be performed by a DMRS pattern manager 1045 as described with reference to FIG. 10.

At 1415, the method may include filtering the additional signal from the data signal based at least in part on the first DMRS pattern associated with the additional signal. The operations of 1415 may be performed in accordance with examples as disclosed herein. In some examples, aspects of the operations of 1415 may be performed by a signal filtering manager 1050 as described with reference to FIG. 10.

At 1420, the method may include decoding the data signal based at least in part on the filtering. The operations of 1420 may be performed in accordance with examples as disclosed herein. In some examples, aspects of the operations of 1420 may be performed by a signal decoding manager 1055 as described with reference to FIG. 10.

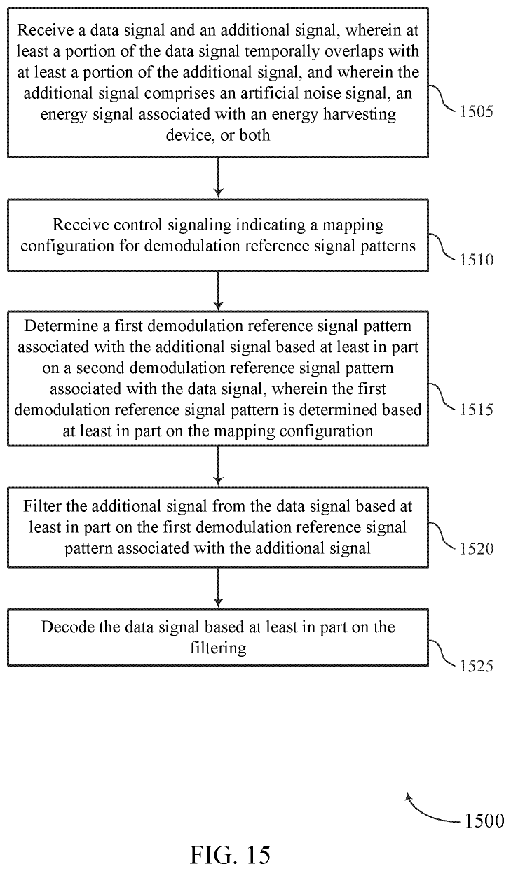

FIG. 15 shows a flowchart illustrating a method 1500 that supports techniques for multiplexing data and non-data signals in accordance with one or more aspects of the present disclosure. The operations of the method 1500 may be implemented by a UE or its components as described herein. For example, the operations of the method 1500 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1505, the method may include receiving a data signal and an additional signal, where at least a portion of the data signal temporally overlaps with at least a portion of the additional signal, and where the additional signal includes an artificial noise signal, an energy signal associated with an energy harvesting device, or both. The operations of 1505 may be performed in accordance with examples as disclosed herein. In some examples, aspects of the operations of 1505 may be performed by a signal receiving manager 1040 as described with reference to FIG. 10.

At 1510, the method may include receiving control signaling indicating a mapping configuration for DMRS patterns, where the first DMRS pattern is determined based on the mapping configuration. The operations of 1510 may be performed in accordance with examples as disclosed herein. In some examples, aspects of the operations of 1510 may be performed by a signal receiving manager 1040 as described with reference to FIG. 10.

At 1515, the method may include determining a first DMRS pattern associated with the additional signal based at least in part on a second DMRS pattern associated with the data signal. The operations of 1515 may be performed in accordance with examples as disclosed herein. In some examples, aspects of the operations of 1515 may be performed by a DMRS pattern manager 1045 as described with reference to FIG. 10.

At 1520, the method may include filtering the additional signal from the data signal based at least in part on the first DMRS pattern associated with the additional signal. The operations of 1520 may be performed in accordance with examples as disclosed herein. In some examples, aspects of the operations of 1520 may be performed by a signal filtering manager 1050 as described with reference to FIG. 10.

At 1525, the method may include decoding the data signal based at least in part on the filtering. The operations of 1525 may be performed in accordance with examples as disclosed herein. In some examples, aspects of the operations of 1525 may be performed by a signal decoding manager 1055 as described with reference to FIG. 10.

The following provides an overview of aspects of the present disclosure:

Aspect 1: A method for wireless communication at a wireless device, comprising: receiving scheduling information that schedules temporally overlapping transmissions by the wireless device of a data signal and an additional signal, wherein the additional signal comprises an artificial noise signal, an energy signal associated with an energy-harvesting device, or both; aligning a starting symbol of the additional signal with a starting symbol of the data signal based at least in part on the data signal and the additional signal being scheduled to temporally overlap; and transmitting the data signal and the additional signal based at least in part on the aligning.

Aspect 2: The method of aspect 1, wherein the scheduling information schedules the data signal that is longer than the additional signal, the method further comprising: modifying a length of the data signal such that the data signal includes a first quantity of symbols that is less than or equal to a second quantity of signals associated with the additional signal, wherein aligning the starting symbol of the additional signal with the starting symbol of the data signal is based at least in part on the modifying.

Aspect 3: The method of any of aspects 1 through 2, wherein the scheduling information schedules the additional signal comprising the artificial noise signal that is longer than the data signal, the method further comprising: modifying a length of the additional signal such that the additional signal and the data signal include equal quantities of symbols, wherein aligning the starting symbol of the additional signal with the starting symbol of the data signal is based at least in part on the modifying.

Aspect 4: The method of aspect 3, wherein the additional signal is scheduled to be transmitted to a second wireless device, the method further comprising: transmitting an indication of the modifying to the second wireless device, wherein transmitting the additional signal is based at least in part on transmitting the indication of the modifying.

Aspect 5: The method of any of aspects 1 through 4, wherein the data signal comprises a first quantity of symbols and the additional signal includes a second quantity of symbols that is greater than the first quantity of symbols.

Aspect 6: The method of aspect 5, wherein the additional signal includes a first portion that temporally overlaps with the data signal and a second portion that does not temporally overlap with the data signal, the method further comprising: transmitting the first portion of the additional signal in accordance with a first transmit power; and transmitting the second portion of the additional signal in accordance with a second transmit power that is greater than the first transmit power based at least in part on the second portion of the additional signal not temporally overlapping with the data signal.

Aspect 7: The method of aspect 6, wherein the data signal is transmitted in accordance with a third transmit power, and the second transmit power is based at least in part on a sum of the first transmit power and the third transmit power.

Aspect 8: The method of aspect 7, further comprising: communicating a message indicating a difference between the second transmit power and the sum of the first transmit power and the third transmit power.

Aspect 9: The method of any of aspects 6 through 8, wherein the additional signal is transmitted to a second wireless device, transmitting the second portion of the additional signal in accordance with the second transmit power that is greater than the first transmit power is based at least in part on a first power level of the wireless device being greater than or equal to a first threshold power level, a first charging rate of the wireless device being greater than or equal to a first threshold charging rate, a second power level of the second wireless device less than or equal to a second threshold power level, a second charging rate of the second wireless device being less than or equal to a second threshold charging rate, or any combination thereof.

Aspect 10: The method of any of aspects 1 through 9, wherein the scheduling information schedules the additional signal comprising the energy signal that is shorter than the data signal, the method further comprising: modifying a length of the additional signal such that the additional signal and the data signal include equal quantities of symbols, wherein aligning the starting symbol of the additional signal with the starting symbol of the data signal is based at least in part on the modifying.

Aspect 11: The method of aspect 10, wherein the data signal is scheduled to be transmitted to a second wireless device, and wherein the additional signal is scheduled to be transmitted to the second wireless device, a third wireless device, or both, the method further comprising: transmitting an indication of the modifying to the second wireless device, the third wireless device, or both, wherein transmitting the data signal, transmitting the additional signal, or both, is based at least in part on transmitting the indication of the modifying.

Aspect 12: The method of any of aspects 1 through 11, wherein data signal is associated with a first DMRS pattern and the additional signal is associated with a second DMRS pattern that is based at least in part on the first DMRS pattern.

Aspect 13: The method of any of aspects 1 through 12, wherein the scheduling information further schedules a second data signal that at least partially temporally overlaps with the data signal and the additional signal, further comprising: modifying a length of the additional signal such that the additional signal includes a same quantity of symbols as the data signal, the second data signal, or both, wherein aligning the starting symbol of the additional signal with the starting symbol of the data signal is based at least in part on the modifying.

Aspect 14: The method of aspect 13, further comprising: transmitting the data signal and the modified additional signal to a second wireless device; and transmitting the second data signal and the modified additional signal to a third wireless device different from the second wireless device.

Aspect 15: The method of any of aspects 1 through 14, wherein the scheduling information schedules the wireless device to transmit the additional signal and a second additional signal to a second wireless device, the method further comprising: transmitting a third additional signal to the second wireless device based at least in part on the scheduling information, wherein the third additional signal is based at least in part on the additional signal and the second additional signal.

Aspect 16: The method of aspect 15, wherein the additional signal and the second additional signal are associated with a first set of parameters and a second set of parameters, respectively, and the third additional signal is associated with a third set of parameters that is based at least in part on the first set of parameters and the second set of parameters, the first set of parameters, the second set of parameters, the third set of parameters, or any combination thereof, comprise an allocation size, a transmit power, a target power, a repetition factor, or any combination thereof.

Aspect 17: The method of any of aspects 1 through 16, wherein the additional signal comprises the artificial noise signal that is configured to provide physical layer security for the data signal, an additional data signal, or both, against unintended receiver devices.

Aspect 18: The method of any of aspects 1 through 17, further comprising: transmitting the data signal with a same phase coherency based at least in part on aligning the starting symbol of the additional signal with the starting symbol of the data signal.

Aspect 19: A method for wireless communication at a wireless device, comprising: receiving a data signal and an additional signal, wherein at least a portion of the data signal temporally overlaps with at least a portion of the additional signal, and wherein the additional signal comprises an artificial noise signal, an energy signal associated with an energy harvesting device, or both; determining a first DMRS pattern associated with the additional signal based at least in part on a second DMRS pattern associated with the data signal; filtering the additional signal from the data signal based at least in part on the first DMRS pattern associated with the additional signal; and decoding the data signal based at least in part on the filtering.

Aspect 20: The method of aspect 19, further comprising: receiving control signaling indicating a mapping configuration for DMRS patterns, wherein the first DMRS pattern is determined based at least in part on the mapping configuration.

Aspect 21: The method of any of aspects 19 through 20, further comprising: receiving an indication of the second DMRS pattern, wherein receiving the data signal and determining the first DMRS pattern is based at least in part on receiving the indication of the second DMRS pattern.

Aspect 22: The method of any of aspects 19 through 21, further comprising: receiving scheduling information that schedules the wireless device to receive the data signal and the additional signal from a second wireless device; and receiving, from the second wireless device and based at least in part on the scheduling information, an indication of a modification of the data signal, the additional signal, or both, wherein receiving the data signal and the additional signal is based at least in part on receiving the indication of the modification.

Aspect 23: The method of any of aspects 19 through 22, wherein the data signal comprises a first quantity of symbols and the additional signal includes a second quantity of symbols that is greater than the first quantity of symbols.

Aspect 24: The method of aspect 23, wherein the additional signal includes a first portion that temporally overlaps with the data signal and a second portion that does not temporally overlap with the data signal, the method further comprising: receiving the first portion of the additional signal in accordance with a first transmit power; and receiving the second portion of the additional signal in accordance with a second transmit power that is greater than the first transmit power based at least in part on the second portion of the additional signal not temporally overlapping with the data signal.

Aspect 25: The method of aspect 24, wherein the data signal is received in accordance with a third transmit power, and the second transmit power is based at least in part on a sum of the first transmit power and the third transmit power.

Aspect 26: The method of aspect 25, further comprising: receiving a message indicating a difference between the second transmit power and the sum of the first transmit power and the third transmit power.

Aspect 27: The method of any of aspects 19 through 26, wherein the additional signal comprises the artificial noise signal that is configured to provide physical layer security for the data signal, an additional data signal, or both, against unintended receiver devices.

Aspect 28: The method of any of aspects 19 through 27, further comprising: decoding the data signal based at least in part on the data signal comprising a same phase coherency across the data signal.

Aspect 29: An apparatus comprising a processor; memory coupled with the processor; and instructions stored in the memory and executable by the processor to cause the apparatus to perform a method of any of aspects 1 through 18.

Aspect 30: An apparatus comprising at least one means for performing a method of any of aspects 1 through 18.

Aspect 31: A non-transitory computer-readable medium storing code the code comprising instructions executable by a processor to perform a method of any of aspects 1 through 18.

Aspect 32: An apparatus comprising at least one processor, memory coupled to the at least one processor, the memory storing instructions executable by the at least one processor to cause the apparatus to perform a method of any of aspects 19 through 28.

Aspect 33: An apparatus comprising at least one means for performing a method of any of aspects 19 through 28.

Aspect 34: A non-transitory computer-readable medium storing code the code comprising instructions executable by a processor to perform a method of any of aspects 19 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a wireless device, comprising:
at least one processor; and
memory coupled to the at least one processor, the memory storing instructions executable by the at least one processor to cause the wireless device to:
receive scheduling information that schedules temporally overlapping transmissions by the wireless device of a data signal and an additional signal, wherein the additional signal comprises an artificial noise signal, an energy signal associated with an energy-harvesting device, or both;
align a starting symbol of the additional signal with a starting symbol of the data signal based at least in part on the data signal and the additional signal being scheduled to temporally overlap; and
transmit the data signal and the additional signal based at least in part on the aligning.

2. The apparatus of claim 1, wherein the scheduling information schedules the data signal that is longer than the additional signal, wherein the instructions are further executable by the at least one processor to cause the wireless device to:
modify a length of the data signal such that the data signal includes a first quantity of symbols that is less than or equal to a second quantity of signals associated with the additional signal, wherein aligning the starting symbol of the additional signal with the starting symbol of the data signal is based at least in part on the modifying.

3. The apparatus of claim 1, wherein the scheduling information schedules the additional signal comprising the artificial noise signal that is longer than the data signal, wherein the instructions are further executable by the at least one processor to cause the wireless device to:
modify a length of the additional signal such that the additional signal and the data signal include equal quantities of symbols, wherein aligning the starting symbol of the additional signal with the starting symbol of the data signal is based at least in part on the modifying.

4. The apparatus of claim 3, wherein the additional signal is scheduled to be transmitted to a second wireless device, wherein the instructions are further executable by the at least one processor to cause the wireless device to:
transmit an indication of the modifying to the second wireless device, wherein transmitting the additional signal is based at least in part on transmitting the indication of the modifying.

5. The apparatus of claim 1, wherein the data signal comprises a first quantity of symbols and the additional signal includes a second quantity of symbols that is greater than the first quantity of symbols.

6. The apparatus of claim 5, wherein the additional signal includes a first portion that temporally overlaps with the data signal and a second portion that does not temporally overlap with the data signal, wherein the instructions are further executable by the at least one processor to cause the wireless device to:
transmit the first portion of the additional signal in accordance with a first transmit power; and
transmit the second portion of the additional signal in accordance with a second transmit power that is greater than the first transmit power based at least in part on the second portion of the additional signal not temporally overlapping with the data signal.

7. The apparatus of claim 6, wherein the data signal is transmitted in accordance with a third transmit power, and wherein the second transmit power is based at least in part on a sum of the first transmit power and the third transmit power.

8. The apparatus of claim 7, wherein the instructions are further executable by the at least one processor to cause the wireless device to:
communicate a message indicating a difference between the second transmit power and the sum of the first transmit power and the third transmit power.

9. The apparatus of claim 6, wherein the additional signal is transmitted to a second wireless device, wherein transmitting the second portion of the additional signal in accordance with the second transmit power that is greater than the first transmit power is based at least in part on a first power level of the wireless device being greater than or equal to a first threshold power level, a first charging rate of the wireless device being greater than or equal to a first threshold charging rate, a second power level of the second wireless device less than or equal to a second threshold power level, a second charging rate of the second wireless device being less than or equal to a second threshold charging rate, or any combination thereof.

10. The apparatus of claim 1, wherein the scheduling information schedules the additional signal comprising the energy signal that is shorter than the data signal, wherein the instructions are further executable by the at least one processor to cause the wireless device to:
modify a length of the additional signal such that the additional signal and the data signal include equal quantities of symbols, wherein aligning the starting symbol of the additional signal with the starting symbol of the data signal is based at least in part on the modifying.

11. The apparatus of claim 10, wherein the data signal is scheduled to be transmitted to a second wireless device, and wherein the additional signal is scheduled to be transmitted to the second wireless device, a third wireless device, or both, wherein the instructions are further executable by the at least one processor to cause the wireless device to:
transmit an indication of the modifying to the second wireless device, the third wireless device, or both, wherein transmitting the data signal, transmitting the additional signal, or both, is based at least in part on transmitting the indication of the modifying.

12. The apparatus of claim 1, wherein data signal is associated with a first demodulation reference signal pattern and the additional signal is associated with a second demodulation reference signal pattern that is based at least in part on the first demodulation reference signal pattern.

13. The apparatus of claim 1, wherein the scheduling information further schedules a second data signal that at least partially temporally overlaps with the data signal and the additional signal, wherein the instructions are further executable by the at least one processor to cause the wireless device to:
modify a length of the additional signal such that the additional signal includes a same quantity of symbols as the data signal, the second data signal, or both, wherein aligning the starting symbol of the additional signal with the starting symbol of the data signal is based at least in part on the modifying.

14. The apparatus of claim 13, wherein the instructions are further executable by the at least one processor to cause the wireless device to:
transmit the data signal and the modified additional signal to a second wireless device; and
transmit the second data signal and the modified additional signal to a third wireless device different from the second wireless device.

15. The apparatus of claim 1, wherein the scheduling information schedules the wireless device to transmit the additional signal and a second additional signal to a second wireless device, wherein the instructions are further executable by the at least one processor to cause the wireless device to:
transmit a third additional signal to the second wireless device based at least in part on the scheduling information, wherein the third additional signal is based at least in part on the additional signal and the second additional signal.

16. The apparatus of claim 15, wherein the additional signal and the second additional signal are associated with a first set of parameters and a second set of parameters, respectively, and wherein the third additional signal is associated with a third set of parameters that is based at least in part on the first set of parameters and the second set of parameters, wherein the first set of parameters, the second set of parameters, the third set of parameters, or any combination thereof, comprise an allocation size, a transmit power, a target power, a repetition factor, or any combination thereof.

17. The apparatus of claim 1, wherein the additional signal comprises the artificial noise signal that is configured to provide physical layer security for the data signal, an additional data signal, or both, against unintended receiver devices.

18. The apparatus of claim 1, wherein the instructions are further executable by the at least one processor to cause the wireless device to:
transmit the data signal with a same phase coherency based at least in part on aligning the starting symbol of the additional signal with the starting symbol of the data signal.

19. An apparatus for wireless communication at a wireless device, comprising:
at least one processor; and
memory coupled to the at least one processor, the memory storing instructions executable by the at least one processor to cause the wireless device to:
receive a data signal and an additional signal, wherein at least a portion of the data signal temporally overlaps with at least a portion of the additional signal, and wherein the additional signal comprises an artificial noise signal, an energy signal associated with an energy harvesting device, or both;
determine a first demodulation reference signal pattern associated with the additional signal based at least in part on a second demodulation reference signal pattern associated with the data signal;
filter the additional signal from the data signal based at least in part on the first demodulation reference signal pattern associated with the additional signal; and
decode the data signal based at least in part on the filtering.

20. The apparatus of claim 19, wherein the instructions are further executable by the at least one processor to cause the wireless device to:
receive control signaling indicating a mapping configuration for demodulation reference signal patterns, wherein the first demodulation reference signal pattern is determined based at least in part on the mapping configuration.

21. The apparatus of claim 19, wherein the instructions are further executable by the at least one processor to cause the wireless device to:
receive an indication of the second demodulation reference signal pattern, wherein receiving the data signal and determining the first demodulation reference signal pattern is based at least in part on receiving the indication of the second demodulation reference signal pattern.

22. The apparatus of claim 19, wherein the instructions are further executable by the at least one processor to cause the wireless device to:
receive scheduling information that schedules the wireless device to receive the data signal and the additional signal from a second wireless device; and
receive, from the second wireless device and based at least in part on the scheduling information, an indication of a modification of the data signal, the additional signal, or both, wherein receiving the data signal and the additional signal is based at least in part on receiving the indication of the modification.

23. The apparatus of claim 19, wherein the data signal comprises a first quantity of symbols and the additional signal includes a second quantity of symbols that is greater than the first quantity of symbols.

24. The apparatus of claim 23, wherein the additional signal includes a first portion that temporally overlaps with the data signal and a second portion that does not temporally overlap with the data signal, and the instructions are further executable by the at least one processor to cause the wireless device to:
receive the first portion of the additional signal in accordance with a first transmit power; and
receive the second portion of the additional signal in accordance with a second transmit power that is greater than the first transmit power based at least in part on the second portion of the additional signal not temporally overlapping with the data signal.

25. The apparatus of claim 24, wherein the data signal is received in accordance with a third transmit power, and wherein the second transmit power is based at least in part on a sum of the first transmit power and the third transmit power.

26. The apparatus of claim 25, wherein the instructions are further executable by the at least one processor to cause the wireless device to:
receive a message indicating a difference between the second transmit power and the sum of the first transmit power and the third transmit power.

27. The apparatus of claim 19, wherein the additional signal comprises the artificial noise signal that is configured to provide physical layer security for the data signal, an additional data signal, or both, against unintended receiver devices.

28. The apparatus of claim 19, wherein the instructions are further executable by the at least one processor to cause the wireless device to:
decode the data signal based at least in part on the data signal comprising a same phase coherency across the data signal.

29. A method for wireless communication at a wireless device, comprising:
receiving scheduling information that schedules temporally overlapping transmissions by the wireless device of a data signal and an additional signal, wherein the additional signal comprises an artificial noise signal, an energy signal associated with an energy-harvesting device, or both;
aligning a starting symbol of the additional signal with a starting symbol of the data signal based at least in part on the data signal and the additional signal being scheduled to temporally overlap; and
transmitting the data signal and the additional signal based at least in part on the aligning.

30. A method for wireless communication at a wireless device, comprising:
receiving a data signal and an additional signal, wherein at least a portion of the data signal temporally overlaps with at least a portion of the additional signal, and wherein the additional signal comprises an artificial noise signal, an energy signal associated with an energy harvesting device, or both;
determining a first demodulation reference signal pattern associated with the additional signal based at least in part on a second demodulation reference signal pattern associated with the data signal;
filtering the additional signal from the data signal based at least in part on the first demodulation reference signal pattern associated with the additional signal; and
decoding the data signal based at least in part on the filtering.
